(19) United States
(12) Patent Application Publication
(10) Pub. No.: US 2026/0329641 A1
(43) Pub. Date: Oct. 22, 2026

(54) MEMORY MANAGEMENT FOR MULTI-TASK EXECUTION OF ARTIFICIAL INTELLIGENCE MODELS

(71) Applicant: QUALCOMM Incorporated, San Diego, CA (US)

(72) Inventors: Chirag Maheshkumar PUJARA, Bangalore (IN); Vinit SOUMYA, Bangalore (IN); Rahul KEDAR, Navi Mumbai (IN); Praveen Kumar VANGALA, Hyderabad (IN); Titash RAKSHIT, Austin, TX (US); Shikhar SRIVASTAVA, Hyderabad (IN)

(21) Appl. No.: 19/182,260

(22) Filed: Apr. 17, 2025

(51) Int. Cl. G06F 9/50; G06F 9/48

(52) U.S. Cl. CPC G06F 9/5016; G06F 9/4881; G06F 9/5022

(57) ABSTRACT

Various aspects relate to multi-task execution of Artificial Intelligence (AI) models. A representation output is obtained in a first memory partition of a plurality of memory partitions of an execution memory of a device. Based on the representation output obtained in the first memory partition, a second memory partition of the plurality of memory partitions is acquired for a first decoding model of two or more decoding models at the device. The acquired second memory partition is loaded with the first decoding model and the loaded first decoding model is then executed based on the representation output in the first memory partition.

### BACKGROUND

### Field of the Disclosure

The present disclosure relates generally to multi-task execution, and, more particularly, to optimizing multi-task execution of artificial intelligence models.

### Description of Related Art

Electronic devices such as smartphones, tablets, wearable electronics, smart televisions, and various additional computing devices incorporate processing capabilities to support a variety of applications. These applications may involve handling different types of data, such as video, audio, or sensor inputs, for various functionalities such as real-time analysis, object detection, extended or augmented reality, or the like. In cases such as video processing, multiple tasks may run concurrently.

Many processing pipelines involve an initial stage that extracts feature representations from input data. Subsequent stages then utilize the extracted feature representations to perform specific tasks. The initial stage may include an encoding model that processes the input data to generate feature representations, and the subsequent stages may include decoding models that utilize the feature representations for different tasks. For example, in video processing, an encoding model may extract feature representations from video frames, and the extracted feature representations may be processed by different decoding models handling tasks such as motion estimation, gesture recognition, object segmentation, or the like.

However, inefficiencies may arise when different tasks have inference at varying rates, for example, at different frames per second in the case of video processing. Executing the encoding model at an inference rate of the slowest decoding model may introduce processing delays, while executing the decoding models at the highest inference rate may lead to computational overhead. There are opportunities to optimize multi-task execution to reduce computational overhead and improve performance across different application scenarios.

### SUMMARY

Aspects of the disclosure provide a device that includes two or more decoding models, an execution memory, and one or more processors. The two or more decoding models are associated with two or more tasks, respectively. The execution memory comprises a plurality of memory partitions. The one or more processors individually or collectively are configured to obtain a representation output in a first memory partition of the plurality of memory partitions, and acquire, based on the representation output obtained in the first memory partition, a second memory partition of the plurality of memory partitions for a first decoding model of the two or more decoding models. The one or more processors individually or collectively are configured to load the acquired second memory partition with the first decoding model and execute the loaded first decoding model based on the representation output in the first memory partition.

In certain aspects of the disclosure, a method is provided. The method comprises obtaining a representation output in a first memory partition of a plurality of memory partitions of an execution memory, and acquiring, based on the representation output obtained in the first memory partition, a second memory partition of the plurality of memory partitions for a first decoding model of two or more decoding models. The two or more decoding models are associated with two or more tasks, respectively. The method comprises loading the acquired second memory partition with the first decoding model, and executing the loaded first decoding model based on the representation output in the first memory partition.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates an example of a multi-task device that supports multi-task execution of artificial intelligence (AI) models, in accordance with certain aspects of the present disclosure;

FIG. 2A is a diagram of an example scenario that illustrates optimization of memory management for multi-task execution of AI models, in accordance with certain aspects of the present disclosure;

FIG. 2B is a diagram of an example scenario that illustrates changing availability statuses of memory partitions of an execution memory in a multi-task inference cycle, in accordance with certain aspects of the present disclosure;

FIG. 2C is a diagram of an example scenario that illustrates a state transition diagram for multi-task execution of AI models across different inference cycles, in accordance with certain aspects of the present disclosure;

FIG. 3A is a diagram of an example scenario that illustrates optimization of memory management for multi-task execution of AI models, in accordance with certain aspects of the present disclosure;

FIG. 3B is a diagram of an example scenario that illustrates changing availability statuses of memory partitions of an execution memory in a multi-task inference cycle, in accordance with certain aspects of the present disclosure;

FIG. 4 is a diagram that illustrates an example of a multi-task device that supports multi-task execution of AI models, in accordance with certain aspects of the present disclosure;

FIG. 5A is a diagram of an example scenario that illustrates optimization of memory management for multi-task execution of AI models, in accordance with certain aspects of the present disclosure;

FIG. 5B is a diagram of an example scenario that illustrates changing availability statuses of memory partitions of an execution memory in a multi-task inference cycle, in accordance with certain aspects of the present disclosure;

FIG. 5C is a diagram of an example scenario that illustrates a state transition diagram for multi-task execution of AI models across different inference cycles, in accordance with certain aspects of the present disclosure;

FIG. 6 is a diagram of an example scenario that illustrates multi-task execution of AI models in a split rendering mode, in accordance with certain aspects of the present disclosure;

FIG. 7 is a diagram of an example scenario that illustrates multi-task execution of AI models, in accordance with certain aspects of the present disclosure;

FIG. 8 is a high-level flowchart that illustrates a method (e.g., a process) executed at a device to optimize multi-task execution of AI models, in accordance with certain aspects of the present disclosure;

FIG. 9 is a detailed flowchart that illustrates a method (e.g., a process) executed at a device to optimize memory management for multi-task execution of AI models, in accordance with certain aspects of the present disclosure;

FIG. 10 is a detailed flowchart that illustrates a method (e.g., a process) executed at a device to optimize multi-task execution of AI models, in accordance with certain aspects of the present disclosure;

FIG. 11 is a detailed flowchart that illustrates a method (e.g., a process) executed at a device to optimize multi-task execution of AI models, in accordance with certain aspects of the present disclosure; and

FIG. 12 is a high-level flowchart that illustrates a method (e.g., a process) executed at a device to optimize multi-task execution of AI models, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Electronic devices such as smartphones, tablets, wearable electronics, smart televisions, and various computing devices support a variety of applications. These applications may involve handling different types of data, such as video, audio, or sensor inputs, for various functionalities such as real-time analysis, object detection, extended reality, or the like. In cases such as video processing, multiple tasks may run concurrently. Many processing pipelines include an initial stage that extracts feature representations from input data, which are then utilized by multiple subsequent stages to perform specific tasks. This can be achieved through an encoding model that processes the input data to generate feature representations, followed by multiple decoding models that utilize the feature representations for different tasks. However, inefficiencies may arise when these tasks involve inference at different cadences, such as varying frames per second in the case of video processing. Executing the encoding model at the slowest rate may cause delays, while executing the decoding models at the highest rate may increase computational overhead.

In light of the foregoing, various aspects of the present disclosure provide a technical solution that optimizes multi-task execution by isolating (or separating) the encoding model from the decoding models without an additional impact on main memory access (e.g., double data rate “DDR” memory access). Thus, allowing the encoding model to be executed at the highest inference cadence, while the decoding models operate at respective inference cadences. This may enable efficient utilization of computational resources without delays or computational overhead.

In many aspects, a device may include two or more decoding models associated with two or more tasks, respectively. In an example, a decoding model may correspond to a computational module, such as an artificial intelligence (AI) model or a machine learning (ML) model, which can process encoded feature representations, extract meaningful information from the encoded feature representations, and generate task-specific outputs. The decoding model may apply one or more transformations (e.g., task-specific transformations) to the encoded feature representations to generate the task-specific outputs. In the case of a video/image processing application, the two or more tasks may include, for example, object detection, background segmentation, human depth estimation, scene segmentation, scene light estimation, object tracking, gesture recognition, gaze tracking, pose estimation, or the like.

The device may also include an execution memory and one or more processors coupled to the execution memory. In an example, the execution memory may correspond to a tightly coupled memory (TCM), a vector-based tightly coupled memory (VTCM), or any low-latency, high-speed memory that is accessible by the one or more processors for real-time/near real-time execution. The execution memory may be utilized for vectorized computations, for example, computations utilized in AI/ML workloads. The execution memory can be directly accessed by the one or more processors, for example, without cache or memory controller interference. The execution memory may include a plurality of memory partitions. In an example, the plurality of memory partitions may be accessible concurrently, by the one or more processors, for different functions.

The one or more processors may be individually or collectively configured to obtain a representation output in a first memory partition of the plurality of memory partitions. In an example, the representation output may refer to processed data derived or extracted from input data such as image or video frames, in the case of the video/image processing application. The representation output may include structured feature information that can serve as an intermediate representation for the two or more tasks. The representation output can be in the form of, for example, a feature map, an embedding, a latent vector, a compressed representation, or the like. In an example, the representation output may correspond to an output of an encoding model. The representation output can be received by the device over a communication channel or generated locally at the device.

The one or more processors may be individually or collectively configured to acquire a second memory partition of the plurality of memory partitions for a first decoding model of the two or more decoding models. The one or more processors may acquire the second memory partition based on the representation output obtained in the first memory partition. In an example, the second memory partition may correspond to any memory partition of the execution memory that is different from the first memory partition in which the representation output is obtained. In an example, based on the acquiring of the second memory partition, the one or more processors may gain access to the second memory partition for real-time or near real-time execution. The one or more processors may be individually or collectively configured to load the acquired second memory partition with the first decoding model and execute the loaded first decoding model based on the representation output in the first memory partition.

Thus, by leveraging the partitioned and sharable execution memory, a representation output of the encoding model is stored (e.g., obtained) in one of the plurality of memory partitions, allowing any of the two or more decoding models to be dynamically loaded into any of the remaining memory partitions of the plurality of memory partitions at respective inference cadences for execution.

In an example scenario, for a video running at 30 frames per second (FPS), representation outputs may be obtained per frame in the first memory partition. The two or more decoding models may include an object detection decoding model operating at 30 FPS, a motion estimation decoding model operating at 15 FPS, and an action recognition decoding model operating at 10 FPS. Based on the respective inference cadences, the object detection decoding model may be configured to process the representation outputs obtained per frame (e.g., frames 0, 1, 2, 3, 4, or the like), whereas the motion estimation decoding model may be configured to process representation outputs obtained every second frame (e.g., frames 0, 2, 4, or the like) and the action recognition decoding model may be configured to process representation outputs obtained every third frame (e.g., frames 0, 3, 6, 9, or the like). For the representation output of any given frame obtained in the first memory partition, any of the two or more decoding models as per the respective inference cadences can be loaded into any of the remaining memory partitions and executed utilizing the obtained representation output. For example, for a representation output of frame 0, the three decoding models can be loaded into the execution memory independently (either sequentially or parallelly) while the representation output remains in the first memory partition throughout the execution of the three decoding models. Similarly, for a representation output of frame 1 obtained in the first memory partition, only the object detection decoding model is loaded into the execution memory and executed, while for a representation output of frame 2 obtained in the first memory partition, both the object detection decoding model and the motion estimation decoding model may be loaded and executed.

Thus, by enabling the two or more decoding models to operate independently of the encoding model while still utilizing shared representation output from the first memory partition, various aspects of the present disclosure allow the encoding model to be executed at the highest inference cadence without introducing memory bandwidth constraints or computational overhead. Additionally, various aspects of the present disclosure may eliminate the involvement of main memory access to fetch the representation output of the isolated encoding model separately for each decoding model execution as the representation output remains in the first memory partition until next representation output is obtained or until decoding models corresponding to the representation output are loaded and executed.

Additionally, executing the two or more decoding models in a split mode, where the encoding model and the two or more decoding models run separately, may allow for seamless addition of new decoding models via over-the-air (OTA) updates. Such an approach may enable dynamic expansion of decoding capabilities of the device, where the one or more processors can be updated to integrate newly added decoding models without disrupting operations of the existing decoding models.

In various aspects, the one or more processors may also be individually or collectively configured to track an availability status of each of the plurality of memory partitions and dynamically transition between various operational states based on the tracked availability statuses. Various operational states may include unclaimed, claimed, and decoding. In an example, the one or more processors may transition to the unclaimed state, based on the availability status of each of the first memory partition and the second memory partition being unallocated. Thus, prior to the obtaining of the representation output in the first memory partition and the loading of the first decoding model in the second memory partition, the one or more processors may be in the unclaimed state. In more examples, the one or more processors may transition to the claimed state, based on the availability status of the first memory partition being allocated and the availability status of the second memory partition being unallocated. Thus, upon the obtaining of the representation output in the first memory partition and prior to the loading of the first decoding model in the second memory partition, the one or more processors may be in the claimed state. In additional examples, the one or more processors may transition to the decoding state, based on the availability status of each of the first memory partition and the second memory partition being allocated. Thus, upon the obtaining of the representation output in the first memory partition and the loading of the first decoding model in the second memory partition, the one or more processors may be in the decoding state. From the decoding state, the one or more processors can transition to any of the unclaimed state or the claimed state based on a change in the availability status of the first memory partition and the second memory partition.

Various aspects of the present disclosure provide memory management for multi-task execution of artificial intelligence (AI) models (e.g., the encoding model and the decoding models) to reduce computational overhead and improve performance across different application scenarios.

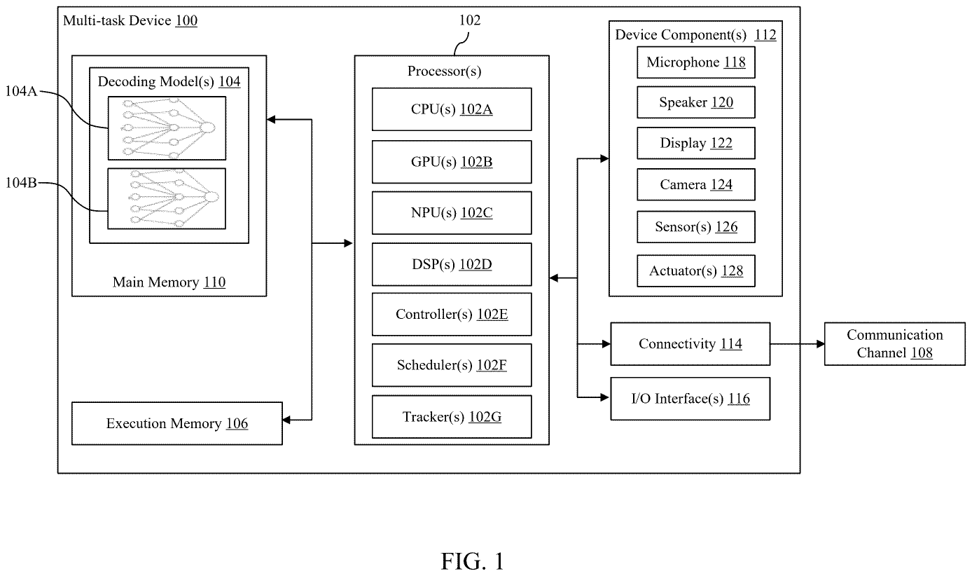

FIG. 1 is a diagram that illustrates an example of a multi-task device 100 that supports multi-task execution of artificial intelligence (AI) models, in accordance with certain aspects of the present disclosure. Examples of the multi-task device 100 may include a smartphone, a laptop, a personal computer, a video server, a tablet, wearable electronics, a smart television, an Internet of Things (IoT) device, an extended reality (XR) device (e.g., a virtual reality “VR” device, a mixed reality “MR” device, or an augmented reality “AR” device), or various additional computing devices. In many aspects, the multi-task device 100 may include one or more processors 102, two or more decoding models 104, and an execution memory 106.

In many aspects, the processor(s) 102 may include, for example and without limitation, one or more central processing units “CPU(s)” 102A, one or more graphics processing units “GPU(s)” 102B, one or more neural processing units “NPU(s)” 102C, one or more digital signal processors “DSP(s)” 102D, one or more controllers 102E, one or more schedulers 102F, or one or more trackers 102G to individually or collectively perform one or more functions described herein. In an example, the DSP(s) 102D may include an image signal processor. In many aspects, the CPU(s) 102A, the GPU(s) 102B, the NPU(s) 102C, the DSP(s) 102D, the controller(s) 102E, the scheduler(s) 102F, and/or the tracker(s) 102G can include electronic circuits or other electronic hardware, such as one or more programmable electronic circuits. The CPU(s) 102A, the GPU(s) 102B, the NPU(s) 102C, the DSP(s) 102D, the controller(s) 102E, the scheduler(s) 102F, and/or the tracker(s) 102G can implement or execute computer software, firmware, or any combination thereof, to perform the various operations described herein. The software and/or firmware can include one or more instructions stored on a computer-readable storage medium and executable by the processor(s) 102. In some aspects, one or more of the CPU(s) 102A, the GPU(s) 102B, the NPU(s) 102C, the DSP(s) 102D, the controller(s) 102E, the scheduler(s) 102F, and/or the tracker(s) 102G can individually or collectively perform various operations to optimize memory management for multi-task execution of the two or more decoding models 104.

Hereinafter, the two or more decoding models 104 are collectively referred to and designated as the “decoding models 104”. For the sake of brevity and in a non-limiting example, the decoding models 104 is shown to include a first decoding model 104A and a second decoding model 104B. The designation “104”, when used in reference to “a decoding model”, may represent any of the first decoding model 104A or the second decoding model 104B without deviating from the scope of the disclosure. In implementations, the multi-task device 100 can include any number of decoding models 104 (for example, one decoding model or more than two decoding models) without deviating from the scope of the disclosure.

In many aspects, the decoding models 104 may correspond to AI models. AI models may correspond to computational models that can mimic human intelligence. For example, AI models can mimic cognitive functions such as learning, reasoning, problem-solving, perception, and even language understanding. Unlike conventional computer programs that follow a fixed set of instructions, AI models can adapt, improve, and make decisions based on input data and environmental interactions. AI models may encompass a wide range of subfields and techniques, from simple rule-based systems to advanced machine learning and deep learning models.

Machine learning can be considered a subset of AI. Machine learning models can include algorithms and statistical models that computing devices can utilize to perform various tasks by relying on patterns and inferences, without the use of explicit instructions. An example of a machine learning model is a neural network (also referred to as an artificial neural network), which may include an interconnected group of artificial neurons (e.g., neuron models).

Neural networks may be utilized for various applications and/or devices, such as image and/or video coding, image analysis and/or computer vision applications, speech analysis, audio signal analysis, Internet Protocol (IP) cameras, IoT devices, autonomous vehicles, service robots, or the like. Individual nodes in a neural network may emulate biological neurons by taking input data and performing simple operations on the data. The results of the simple operations performed on the input data are selectively passed on to subsequent neurons. Weight values are associated with each vector and node in the neural network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (also referred to as a feature map or an activation map). The weight values may initially be determined by an iterative flow of training data through the neural network (e.g., weight values established during a training phase in which the neural network learns how to identify particular classes based on input data characteristics). Examples of different types of neural networks may include, but not limited to, convolutional neural networks (CNNs), recurrent neural networks (RNNs), generative adversarial networks (GANs), multilayer perceptron (MLP) neural networks, transformer neural networks, or the like.

CNNs correspond to a type of feed-forward artificial neural networks, which include collections of artificial neurons that each have a receptive field (e.g., a spatially localized region of an input space) and that collectively tile an input space. RNNs work on the principle of saving the output of a layer and feeding the output back to the input to help in predicting an outcome of the layer. GAN is a form of generative neural network that can learn patterns in the input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning is one example of an ML and can be considered a subset of ML. Many deep learning approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network may be referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of an ML system, and can include an input layer, one or more hidden layers, and an output layer. Data is provided from input nodes of the input layer, processing is performed by hidden nodes of the one or more hidden layers, and an output is produced through output nodes of the output layer. Deep learning networks may include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

Deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For example, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks can include a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to a different neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

Multi-task execution is an AI-based approach where an output (e.g., a representation output) of an encoding model is utilized by multiple decoding models (e.g., the decoding models 104). In other words, in multi-task execution, the decoding models 104 can leverage a common output of the encoding model to perform distinct tasks (e.g., two or more tasks). By decoupling the encoding model from decoding tasks, multi-task execution can enable efficient use of computational resources, allowing the multi-task device 100 to execute specialized decoding models 104 without involving processing of input data independently for each decoding model 104. In an example, multi-task execution may be beneficial in distributed AI devices, where a common encoding model processes input data and different decoding models 104 perform task-specific operations on the output of the encoding model for executing the two or more tasks.

In an example, the representation output of the encoding model may refer to processed data derived or extracted from input data such as one or more images (e.g., a video of images or frames) in the case of a video/image processing application. The representation output may include structured feature information that can serve as an intermediate representation for the two or more tasks. The representation output can be in the form of, for example, a feature map, an embedding, a latent vector, a compressed representation, or the like. In an example, the representation output can be received by the multi-task device 100 over a communication channel 108. In various aspects, the two or more tasks may include any of object detection, background segmentation, human depth estimation, scene segmentation, scene light estimation, object tracking, gesture recognition, gaze tracking, pose estimation, or the like.

In a case where the task is object detection, a decoding model 104 may be configured to identify and localize objects within a frame (e.g., an image or a video frame) by processing a representation output generated for the frame. For processing the representation output, the decoding model 104 may apply one or more task-specific transformations (for example, convolutional layers, anchor box generation, or attention mechanisms) on the representation output to generate a task-specific output (e.g., an object detection output). For example, the decoding model 104 may identify bounding box coordinates for the frame by processing the representation output. In an example scenario where a frame contains a cat and a dog, the decoding model 104 may process the representation output of the frame and output bounding box coordinates as (x1, y1, x2, y2) for each detected object. For example, the decoding model 104 may predict a bounding box for the cat at (50,100,200,300) and for the dog at (220,150,400,350).

In a case where the task is background segmentation, a decoding model 104 may be configured to distinguish a foreground (main subject) from a background in a frame (e.g., an image or a video frame) based on a representation output associated with the frame. The decoding model 104 may apply one or more task-specific transformations (such as convolutional layers, up-sampling operations, or attention mechanisms) on the representation output and generate a task-specific output, for example, a pixel-wise segmentation mask. In an example scenario where a frame contains a person standing against a cluttered background. The decoding model 104 may process the representation output of the frame and generate a binary segmentation mask, assigning values of ‘1’ to foreground pixels (the person) and ‘0’ to background pixels. The decoding model 104 can also predict a mask where the person occupies pixel regions such as (50,100) to (200,300), effectively segmenting the foreground from the background.

In a case where the task is human depth estimation, a decoding model 104 may be configured to predict depth information of each pixel in a frame (e.g., an image or a video frame) to estimate a distance of a person from a frame capturing source such as a camera. The decoding model 104 may apply one or more task-specific transformations (such as convolutional layers, disparity estimation, or transformer-based depth prediction mechanisms) on the representation output associated with the frame and generate a task-specific output. In an example, the task-specific output can include a dense depth map, where each pixel is assigned a depth value. In an example scenario where a frame contains a person standing at a distance from the camera, the decoding model 104 may predict depth values for different regions, such as assigning a normalized depth value of ‘0.2’ for pixels corresponding to the person's feet (closer to the camera) and ‘0.8’ for pixels corresponding to their head (further away).

In a case where the task is scene segmentation, a decoding model 104 may be configured to classify each pixel in a frame (e.g., an image or a video frame) into different semantic categories (e.g., road, sky, building, vegetation, or the like). The decoding model 104 may apply one or more task-specific transformations (e.g., fully convolutional networks, attention mechanisms, or pyramid pooling modules) on the representation output associated with the frame to generate a task-specific output, for example, a segmentation map. In an example scenario where a frame captures an outdoor environment, the decoding model 104 may assign pixel values representing different objects, such as ‘1’ for the road, ‘2’ for buildings, and ‘3’ for trees, effectively segmenting the scene into one or more meaningful components.

In a case where the task is scene light estimation, a decoding model 104 may be configured to estimate global and local lighting conditions of a scene within a frame (e.g., an image or a video frame). The decoding model 104 may apply one or more task-specific transformations (e.g., spherical harmonics, high dynamic range estimation, or neural relighting models) on the representation output of the frame to generate a task-specific output such as an inference related to an intensity, a direction, and a color temperature of ambient light. In an example scenario where an indoor scene is illuminated by a lamp and natural light from a window, the decoding model 104 may predict light sources positioned at specific coordinates, such as a primary warm light at (150, 200) with an intensity of ‘0.7’ and a secondary cool light at (400, 250) with an intensity of ‘0.4’.

In a case where the task is object tracking, a decoding model 104 may be configured to follow or track a detected object across multiple frames in a video sequence. The decoding model 104 may apply one or more task-specific transformations (e.g., correlation filters attention-based tracking mechanisms, or the like) on the representation output of the multiple frames and generate a task-specific output, for example, determining the detected object's movement trajectory. In an example scenario where a surveillance video captures a moving vehicle, the decoding model 104 may predict the vehicle's position in each frame by generating bounding box coordinates, such as (120, 180, 300, 400) in frame one and (140, 190, 320, 410) in frame two, maintaining the object's identity across time.

In a case where the task is gesture recognition, a decoding model 104 may be configured to identify and classify body gestures within a frame (e.g., an image or a video frame). The decoding model 104 may apply one or more task-specific transformations (e.g., keypoint detection models, spatio-temporal feature extraction mechanisms, or the like) on the representation output of the frame and generate a task-specific output, for example, recognizing different gestures in the frame. In an example scenario where a person waves their hand to signal a command, the decoding model 104 may detect the hand's movement trajectory, assigning a gesture class label such as ‘wave’ with a confidence score of ‘0.9’ based on the keypoint positions of the hand across multiple frames.

In a case where the task is gaze tracking, a decoding model 104 may be configured to estimate the direction of a person's eye movement within a frame (e.g., an image or a video frame). The decoding model 104 may apply one or more task-specific transformations (e.g., facial landmark detection, eye modelling, or the like) on the representation output of the frame and generate a task-specific output, for example, determining a gaze direction. In an example scenario where a person is looking at a specific point on a screen, the decoding model 104 may predict their gaze coordinates as (350, 220) relative to a screen space, determining where the person is focusing.

In a case where the task is pose estimation, a decoding model 104 may be configured to detect and localize keypoints of a human body within a frame (e.g., an image or a video frame). The decoding model 104 may apply one or more task-specific transformations (e.g., heatmap regression, part affinity fields, keypoint detection, or the like) on the representation output of the frame and generate a task-specific output, for example, predict body joint positions. In an example scenario where a person is performing a yoga pose, the decoding model 104 may detect and assign keypoint coordinates such as (100, 200) for the left elbow, (150, 300) for the right knee, and (200, 400) for the left ankle, mapping the person's body posture.

In some aspects, computer vision (CV) tasks are used as example tasks that can be performed by the decoding models 104. However, aspects of the present disclosure are readily applicable to a wide variety of machine learning tasks. For example, in addition to computer vision, execution for other dense prediction tasks (e.g., tasks where the desired prediction or output is dense and/or structured in time and/or space) such as some natural language processing (NLP) tasks can be performed using aspects of the present disclosure. It will be apparent to a person of skill in the art that the examples of the two or more tasks described above are not an exhaustive list but are illustrative examples. Additional or alternate tasks may be executed by the decoding models 104 without deviating from the scope of the disclosure.

In many aspects, the processor(s) 102 may be coupled to the execution memory 106. In an example, the execution memory 106 may correspond to a tightly coupled memory (TCM), a vector-based tightly coupled memory (VTCM), or any low-latency, high-speed memory that is directly accessible by the processor(s) 102 for real-time/near real-time execution of the decoding models 104. The execution memory 106 can be utilized for vectorized computations, for example, computations utilized in AI/ML workloads. The execution memory 106 can be directly accessed by the processor(s) 102, for example, without cache or memory controller interference.

In various aspects, the execution memory 106 may include a plurality of memory partitions. In an example, the execution memory 106 may support a memory sharing feature that allows multiple entities to dynamically and concurrently acquire portions of the execution memory 106 or a single entity to dynamically acquire non-contiguous portions of the execution memory 106 for functional requirements. For example, if a total available size of the execution memory 106 is 8 Megabytes (MB), a CPU 102A can acquire a 6 MB page of the execution memory 106 and a GPU 102B can acquire remaining 2 MB page of the execution memory 106. In further examples, a CPU 102A can acquire a 2 MB page of the execution memory 106 for storing a representation output and a scheduler 102F may utilize at least portion of remaining 6MB page of the execution memory 106 to execute one or more of the decoding models 104. In other words, the plurality of memory partitions may be accessible concurrently, by the processor(s) 102, for different functions.

In numerous aspects, the processor(s) 102 may be individually or collectively configured to obtain a representation output in a first memory partition of the execution memory 106. In an example, the representation output may refer to processed data derived or extracted from input data such as an image or a video frame, in the case of a video/image processing application. In an example, prior to the obtaining, the representation output may be received by the multi-task device 100 over the communication channel 108. In an example, the communication channel 108 may serve as a medium for transmitting data between the multi-task device 100 and any device, system, or network, enabling interaction and information exchange. The communication channel 108 can be established through a wired means (for example, an optical fiber, Ethernet, High Definition Multimedia Interface “HDMI”, Universal Serial Bus “USB” interface, etc.) or through wireless technologies, for example, Wi-Fi, Bluetooth, cellular networks, Zigbee, Near Field Communication, satellite communication, or the like.

In numerous aspects, the processor(s) 102 may be individually or collectively configured to acquire a second memory partition of the execution memory 106 for a decoding model 104 based on the representation output obtained in the first memory partition. The second memory partition is different from the first memory partition and may be acquired concurrently while the first memory partition has the representation output stored therein. In an example, based on the acquiring of the second memory partition, the processor(s) 102 may gain access to the second memory partition for real-time or near real-time execution. The processor(s) 102 may be individually or collectively configured to load the acquired second memory partition with the decoding model 104 and execute the loaded decoding model 104 based on the representation output in the first memory partition.

Thus, by leveraging the execution memory 106, the representation output is stored (e.g., obtained) in one of the plurality of memory partitions, allowing any of the decoding models 104 (for example, the first decoding model 104A or the second decoding model 104B) to be dynamically loaded into any of the remaining memory partitions of the execution memory 106 for execution using the obtained representation output. Thus, the present disclosure enables the decoding models 104 to be operated independently of an encoding model, which generated the representation output, while still utilizing shared representation output from the first memory partition.

In various aspects, upon receiving, the representation output may be obtained in the first memory partition without being routed through a main memory of the multi-task device 100. Such implementation may avoid additional read-write access to the main memory, allowing the loaded decoding model 104 to access the representation output from the first memory partition for processing. Thus, various aspects of the present disclosure may eliminate the involvement of main memory access to fetch the representation output for execution of the decoding models 104 as the representation output may remain in the first memory partition until a next representation output is obtained or until decoding models 104 corresponding to the representation output are loaded and executed. Additionally, data transfer between two memory partitions of the execution memory 106 instead of a main memory can further reduce latency by minimizing unnecessary memory copies.

In an example, the decoding model 104, for execution, may retrieve (or read) the representation output from the first memory partition and apply one or more task-specific transformations corresponding to a task associated with the decoding model 104 on the representation output. In an example, if the decoding model 104 is associated with an object detection task, the decoding model 104 may apply the one or more task-specific transformations corresponding to object detection, whereas if the decoding model 104 is associated with an object tracking task, the decoding model 104 may apply the one or more task-specific transformations corresponding to object tracking. Based on the applied one or more task-specific transformations, the decoding model 104 may generate a task-specific output for the task. In an example, if the task is object detection, the generated task-specific output may correspond to bounding box coordinates for a frame associated with the representation output. Likewise, if the task is background segmentation, the generated task-specific output may correspond to a pixel-wise segmentation mask for the frame associated with the representation output. In other words, based on a task associated with the decoding model 104, the decoding model 104 may process the representation output and generate the task-specific output. In various examples, upon a completion of the execution of the decoding model 104, the processor(s) 102 may be configured to store the task-specific output in a different memory location, forward the task-specific output to a subsequent decoding model for further processing, or utilize the task-specific output for real-time or near real-time decision-making.

In various additional or optional aspects, the multi-task device 100 may include a main memory 110 coupled to the processor(s) 102. The main memory 110 may be configured to store the decoding models 104. Storing a decoding model 104 in the main memory 110 may involve maintaining a structured data representation that encapsulates various parameters and operational configurations of the decoding model 104. In an example, the parameters and operational configurations of a decoding model 104 may include, but not limited to, trained weights, biases, model layer configurations, lookup tables, or the like. The trained weights may determine the strength of connections between different layers (e.g., input layer, hidden layers, output layer, or the like) of the decoding model 104, while biases may adjust activation thresholds of neurons of the decoding model 104. The lookup tables may store pre-computed values to accelerate certain operations, such as activation functions or quantized calculations. Model layer configurations may define layer-wise computations, specifying filter dimensions, kernel strides, and additional operational constraints of the decoding model 104. The processor(s) 102 may be individually or collectively configured to load the second memory partition with the decoding model 104 from the main memory 110 based on the acquiring of the second memory partition. Loading a decoding model 104 from the main memory 110 to the second memory partition may include selectively loading one or more of stored parameters and configurations of the decoding model 104 from the main memory 110 to the execution memory 106.

In an example, the main memory 110 can include Random-Access Memory (RAM), Synchronous Dynamic RAM (SDRAM), static RAM, Non-Volatile RAM (NVRAM), Magnetoresistive RAM (MRAM), or the like. The main memory 110 may be different from the execution memory 106. For example, the main memory 110 may be accessible by the processor(s) 102, for example, with cache or memory controller interference. In an example, the main memory 110 may have higher latency as compared to the execution memory 106.

In various optional aspects, the multi-task device 100 may be a multi-functional device including various hardware and software components that work individually or in conjunction, for example, based on the control of the processor(s) 102. The processor(s) 102 may individually or collectively manage data processing, communication, and interaction between the different hardware and software components. In an example, the multi-task device 100 can additionally or optionally include one or more device components 112, a connectivity element 114, and one or more input/output (I/O) interfaces 116. In an example, the device component(s) 112 may include, but not limited to, a microphone 118, a speaker 120, a display 122, a camera 124, one or more sensors 126, and one or more actuators 128.

In an example, the connectivity element 114 may facilitate communication between the multi-task device 100 and one or more external devices, systems, networks, or peripherals, for example via the communication channel 108. The external devices, systems, networks, or peripherals may include, for example, wireless communication modules such as Wi-Fi, Bluetooth, cellular (e.g., 4G/5G), NFC, or wired connections such as Ethernet, HDMI, USB, optical cable, or the like. The connectivity element 114 may enable various functionalities such as data transfer, remote access, cloud synchronization, device pairing, or the like on the multi-task device 100. For example, in a case where the multi-task device 100 is an XR device (such as an AR device, a VR device, or an MR device), the connectivity element 114 supporting Wi-Fi and cellular network access may enable content streaming, multiplayer gaming, and cloud-based rendering, while the connectivity element 114 supporting Bluetooth access may enable the connection of controllers, motion trackers, audio peripherals, or the like with the multi-task device 100.

In an example, I/O interfaces 116 may serve as communication channels for the multi-task device 100. For example, the multi-task device 100 can include wired and wireless I/O interfaces 116 to enable connectivity with external peripherals, such as USB ports for data transfer or HDMI ports for video output.

In an example, the microphone 118 (e.g., an audio input component) may be configured to capture sound from surrounding environment for communication and/or audio recording. The microphone 118 can also capture voice commands of a user of the multi-task device 100.

In an example, the speaker 120 (e.g., an audio output component) may be configured to generate sound based on one or more processed signals. The speaker 120 may produce various forms of audio, such as voice calls, notifications, multimedia playback, and device alerts. In an example, the speaker 120 may enable hands-free communication and media consumption on the multi-task device 100.

In an example, the display 122 (e.g., a visual output interface) may be configured to render visual and graphical content. In certain aspects, the display 122 can also support one or more interactive capabilities. In many examples, the display 122 may be configured to modify the rendered visual content based on one or more task-specific outputs generated by the decoding models 104 and then render the modified visual content. Various examples of the modification of the visual content may include, but are not limited to an overlay of one or more information cues on the rendered visual content, an adjustment of at least one visual property of the rendered visual content, or a reconfiguration of the rendered visual content.

In an example, the overlay of information cues may include superimposition of one or more additional visual elements over a base content (e.g., the rendered visual content) to provide real-time/near real-time, context-aware, or interactive information. The overlay can be in various forms, for example, text, graphics, icons, notifications, augmented elements, or interactive controls. In various examples, the overlays can be static or dynamic, persistent or temporary.

In an example scenario, in an XR application, the overlay of information cues can provide real-time spatial annotations, navigation markers, product details, live translations, or object identifiers, helping a user to interact with their environment. For instance, based on a task-specific output generated by an executed decoding model 104 for object detection, which identifies roads, landmarks, or obstacles in the rendered visual content, the display 122 may overlay directional arrows or traffic alerts in real-time/near real-time on the rendered visual content. Similarly, in smart glasses (e.g., the multi-task device 100) utilized for industrial applications, task-specific outputs generated by an executed decoding model 104 for object tracking can enable the display 122 to overlay step-by-step assembly instructions onto physical machinery in the rendered visual content. In a gaming application on the multi-task device 100, task-specific outputs generated by an executed decoding model 104 for gaze tracking can enable the display 122 to highlight in-game objectives or display interactive UI elements in the rendered visual content based on where a user is looking.

In an example, the adjustment of at least one visual property of the rendered visual content may include modifying brightness, contrast, transparency, color saturation, depth perception, or the like of rendered visual content. For example, the display 122 in an XR headset (e.g., the multi-task device 100) may dynamically adjust the brightness of a rendered visual content based on a task-specific output generated by an executed decoding model 104 for scene light estimation. Similarly, the display 122 in AR smart glasses (e.g., the multi-task device 100) can enhance the contrast of the rendered visual content to improve text readability based on a task-specific output generated by an executed decoding model 104 for scene light estimation. In more examples, based on a task-specific output generated by an executed decoding model 104 for background segmentation, the display 122 may modify the sharpness or blur intensity of background elements to enhance foreground elements in the rendered visual content. In an accessibility-focused application on the multi-task device 100, the display 122 may perform color adjustments in the rendered visual content based on a task-specific output generated by an executed decoding model 104 for gaze tracking.

In an example, the reconfiguration of the rendered visual content may involve modifying the arrangement, positioning, or scaling of elements within the rendered visual content. For example, based on a task-specific output generated by an executed decoding model 104 for pose estimation, the display 122 may reposition on-screen virtual trainers or adjust exercise instructions dynamically based on a user's posture. Further, based on a task-specific output generated by an executed decoding model 104 for gesture recognition, the display 122 may rearrange one or more virtual user interface (UI) elements on the rendered visual content with recognized hand movements. Likewise, based on a task-specific output generated by an executed decoding model 104 for scene segmentation, the display 122 may reconfigure furniture placement suggestions in real-time based on detected room layout and spatial constraints.

It will be apparent to a person of skill in the art that the examples of the visual content modifications by the display 122, based on a task-specific output of an executed deciding model 104, described above are not an exhaustive list but are illustrative examples. Additional or alternate modification can be applied to a rendered visual content on the display 122 without deviating from the scope of the disclosure.

In an example, the camera 124 (e.g., an optical input component) may be configured to capture images and videos. The camera 124 may include front-facing and rear-facing modules with different resolutions and capabilities.

In an example, the sensor(s) 126 may be input components that are configured to detect one or more environmental conditions and user interactions. Examples of the sensor(s) 126 may include an accelerometer (for motion tracking), a gyroscope (for orientation sensing), a proximity sensor (for detecting nearby objects), an ambient light sensor (for automatic brightness adjustment), a biometric sensor (for fingerprint or facial recognition), or the like.

In an example, the actuator(s) 128 may be output components that are configured to produce a physical movement or a feedback in response to control signals, for example, from the processor(s) 102. Examples of the actuator(s) 128 may include vibration motors (for haptic feedback in smartphones), solenoids (for mechanical movements), or the like.

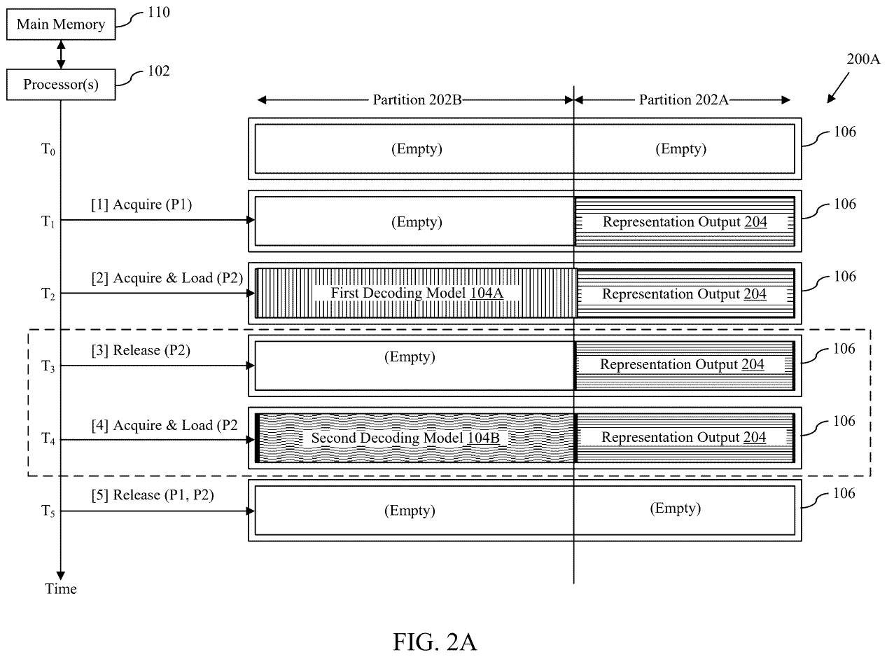

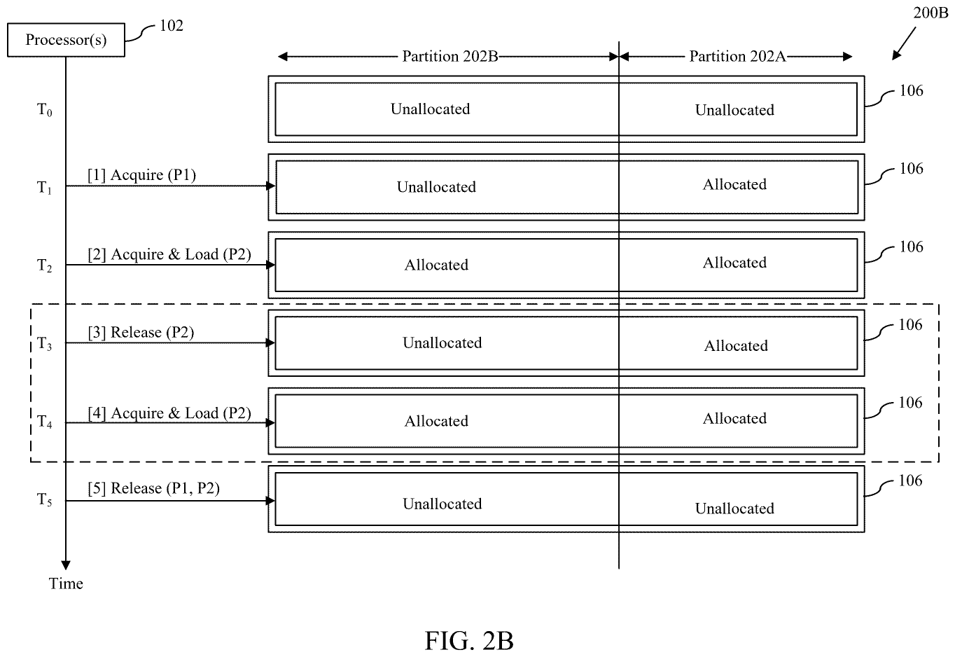

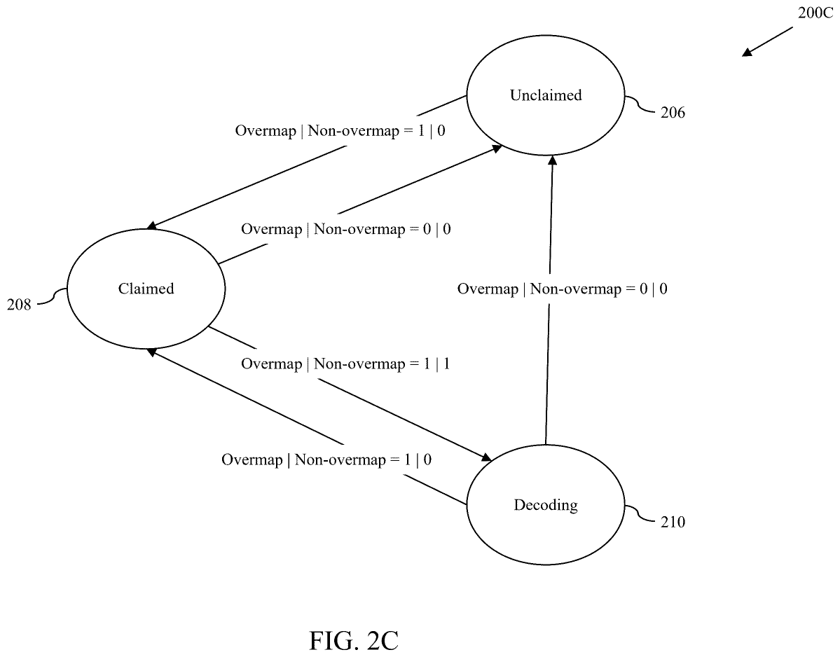

FIG. 2A is a diagram of an example scenario 200A that illustrates optimization of memory management for multi-task execution of AI models, in accordance with certain aspects of the present disclosure. FIG. 2A is described in conjunction with FIG. 1. The example scenario 200A is described with reference to the processor(s) 102, the first decoding model 104A, the second decoding model 104B, the execution memory 106, and the main memory 110 of FIG. 1. In a non-limiting example, the execution memory 106 is shown to include two memory partitions such as a first memory partition 202A (labeled as “partition 202A” in FIG. 2A) and a second memory partition 202B (labeled as “partition 202B” in FIG. 2A). In an example, a size of the first memory partition 202A may be smaller than the second memory partition 202B.

In a variety of aspects, the decoding models 104 may be associated with respective inference cadences. Inference cadence of a decoding model 104 may refer to a rate at which the decoding model 104 may process and generate task-specific outputs. Thus, inference cadence may define how frequently the decoding model 104 can perform inference within a given time frame. In applications such as video processing, inference cadence can be defined in terms of frames per second (FPS), indicating how many video frames the decoding model 104 can decode within one second. In certain aspects, the decoding models 104 can have different inference cadences. Thus, the two decoding models (e.g., the first decoding model 104A and the second decoding model 104B) can operate at different processing rates, affecting how quickly the two decoding models generate outputs relative to each other. For example, in the case of a video processing application, the first decoding model 104A may operate at 60 FPS while the second decoding model 104B can operate at 30 FPS. In such a scenario, the first decoding model 104A generates task-specific outputs for twice as many frames in the same time period as the second decoding model 104B. In an example, the first decoding model 104A may have the highest inference cadence among the decoding models 104. Remaining of the decoding models 104 (e.g., the second decoding model 104B) can have the same or different inference cadences as the first decoding model 104A. For the sake of ongoing description and in a non-limiting example, it is assumed that the first decoding model 104A and the second decoding model 104B have different inference cadences, and the first decoding model 104A has the higher inference cadence between the first decoding model 104A and the second decoding model 104B.

As shown in FIG. 2A, at a time instance T₀, both the first memory partition 202A and the second memory partition 202B are empty. At a subsequent time instance T₁, the processor(s) 102 may obtain a representation output 204 in the first memory partition 202A. As shown in FIG. 2A, at time instance T₁, the first memory partition 202A has the representation output 204 obtained therein. For example, the processor(s) 102 may receive the representation output 204 and acquire the first memory partition 202A to store the received representation output 204. In an example, the processor(s) 102 may transmit a request (e.g., [1] acquire (P1)) to the execution memory 106 to acquire a specific size (e.g., the first memory partition 202A) of the execution memory 106 for storing the representation output 204. In an example, the request may include one or more parameters such as a requesting entity identifier or a page size, which defines a size of the execution memory 106 to be allocated. Additionally or optionally, the request may also include a priority level. In an example, the processor(s) 102 may receive a status response to the request, indicating a success or a failure. In an example, the representation output 204 may be received from an external device.

In various aspects, prior to loading the second memory partition 202B with a decoding model 104, the processor(s) 102 may be individually or collectively configured to identify, among the decoding models 104, a set of decoding models to load in the second memory partition 202B for the representation output 204 based on the respective inference cadences of the decoding models 104. For example, for a video running at 30 FPS, representation outputs may be obtained per frame in the first memory partition 202A. The first decoding model 104A may be operating at 30 FPS and the second decoding model 104B operating at 10 FPS. Based on the respective inference cadences, the first decoding model 104A may be configured to process representation outputs obtained per frame (e.g., frames 0, 1, 2, 3, 4, or the like) whereas the second decoding model 104B may be configured to process representation outputs obtained every third frame (e.g., frames 0, 3, 6, 9, or the like). Thus, for the representation output 204 of a given frame obtained in the first memory partition 202A, the processor(s) 102 may identify which among the decoding models 104 are to be included in the set of decoding models based on the respective inference cadences. Since the first decoding model 104A has the highest inference cadence among the respective inference cadences of the decoding models 104, the set of decoding models identified for a representation output of any given frame may at least include the first decoding model 104A.

In various aspects, a scheduler 102F may be configured to schedule loading and execution of the decoding models 104 based on a fixed time interval N. N may represent the smallest execution period associated with the decoding models 104 and may be determined based on the respective inference cadences of the decoding models 104. For example, if the first decoding model 104A operates at 60 FPS (to be run every 16 milliseconds “ms”) and the second decoding model 104B at 30 FPS (to be run every 32 ms), N may be set to 16 ms which is the smallest execution period among the execution periods (e.g., 16 ms and 32ms) of the decoding models 104. Further, the scheduler 102F may maintain an execution counter and increment the execution counter every 1 ms, selectively loading the decoding models 104 at appropriate multiples of the time interval N. Thus, when the execution counter reaches a multiple of 16, the scheduler 102F may select the first decoding model 104A to be loaded and executed, while at multiples of 32, the scheduler 102F may select both the first decoding model 104A and the second decoding model 104B for loading and execution.

In an example scenario, the representation output 204 may correspond to a 0^{th} frame. In such a scenario, the processor(s) 102 may identify both the first decoding model 104A and the second decoding model 104B to be included as part of the set of decoding models. Upon the identification of the set of decoding models, the processor(s) 102 may be configured to sequentially load the first decoding model 104A and the second decoding model 104B in the second memory partition 202B for execution while the representation output 204 may remain stored in the first memory partition 202A throughout the execution of the first decoding model 104A and the second decoding model 104B.

Continuing the above example scenario of 0^{th} frame, at a subsequent time instance T₂, the processor(s) 102 may be individually or collectively configured to acquire the second memory partition 202B for the first decoding model 104A based on the representation output 204 obtained in the first memory partition 202A and load the acquired second memory partition 202B with the first decoding model 104A from the main memory 110. In an example, the processor(s) 102 may transmit a request (e.g., [2] acquire and load (P2)) to the execution memory 106 to acquire a specific size (e.g., the second memory partition 202B) of the execution memory 106 for loading the first decoding model 104A. Based on the loading of the first decoding model 104A in the second memory partition 202B, the processor(s) 102 may be individually or collectively configured to execute the first decoding model 104A.

In various aspects, to execute the loaded first decoding model 104A, the processor(s) 102 may be individually or collectively configured to provide an identifier of the first memory partition 202A as an input to the first decoding model 104A. Thus, the first decoding model 104A may gain access to the representation output 204 without access of the main memory 110. When the first decoding model 104A receives the identifier of the first memory partition 202A where the representation output 204 is obtained, the first decoding model 104A may utilize the identifier as a memory pointer to access the representation output 204 directly from the first memory partition 202A, rather than involving additional data transfer or duplication of data in the main memory 110.

In many aspects, the first decoding model 104A, for execution, may retrieve (or read) the representation output 204 from the first memory partition 202A. The first decoding model 104A may then apply one or more task-specific transformations corresponding to a first task associated with the first decoding model 104A on the representation output 204 and generate a first task-specific output. In various examples, upon a completion of the execution of the first decoding model 104A, the processor(s) 102 may be configured to store the first task-specific output in a different memory location, forward the first task-specific output to a subsequent decoding model for further processing, or utilize the first task-specific output for real-time or near real-time decision-making.

In an example of real-time or near real-time decision-making, the processor(s) 102 may be individually or collectively configured to control an operation of at least one device component of the device components 112 based on the first task-specific output. In an example, the at least one device component may include the display 122. In such a scenario, based on the control of the operation, the display 122 may be configured to render a visual content, modify the visual content based on the first task-specific output, and then render the modified visual content. Various examples of the modification of the visual content are described in the foregoing description of FIG. 1.

In additional aspects, the processor(s) 102 may be individually or collectively configured to release the acquired second memory partition 202B upon a completion of the execution of the first decoding model 104A, for example, at a time instance T₃. An execution time of the first decoding model 104A may be a difference of the time instances T₃ and T₂. In an example, the processor(s) 102 may transmit a request (e.g., [3] release (P2)) to the execution memory 106 to release the second memory partition 202B. Upon release, the second memory partition 202B may again become empty.

Based on the release of the second memory partition 202B, at a subsequent time instance T₄, the processor(s) 102 may be individually or collectively configured to acquire the second memory partition 202B for the second decoding model 104B in the identified set and load the acquired second memory partition 202B with the second decoding model 104B from the main memory 110. In an example, the processor(s) 102 may transmit a request (e.g., [4] acquire and load (P2)) to the execution memory 106 to acquire the second memory partition 202B for loading the second decoding model 104B. Based on the loading of the second decoding model 104B in the second memory partition 202B, the processor(s) 102 may be individually or collectively configured to execute the second decoding model 104B.

In various aspects, to execute the loaded second decoding model 104B, the processor(s) 102 may be individually or collectively configured to provide an identifier of the first memory partition 202A as an input to the second decoding model 104B. Thus, the second decoding model 104B may gain access to the representation output 204 without accessing the main memory 110. When the second decoding model 104B receives the identifier of the first memory partition 202A where the representation output 204 is obtained, the second decoding model 104B may utilize the identifier as a memory pointer to access the representation output 204 directly from the first memory partition 202A, rather than involving additional data transfer or duplication of data in the main memory 110.

In many aspects, the second decoding model 104B, for execution, may retrieve (or read) the representation output 204 from the first memory partition 202A. The second decoding model 104B may then apply one or more task-specific transformations corresponding to a second task associated with the second decoding model 104B on the representation output 204 and generate a second task-specific output. In various examples, upon a completion of the execution of the second decoding model 104B, the processor(s) 102 may be configured to store the second task-specific output in a different memory location, forward the second task-specific output to a subsequent decoding model (if applicable) for further processing, or utilize the second task-specific output for real-time or near real-time decision-making.

In an example of real-time or near real-time decision-making, the processor(s) 102 may be individually or collectively configured to control an operation of the display 122 based on the second task-specific output. Based on the control of the operation, the display 122 may be configured to further modify the visual content based on the second task-specific output and then render the further modified visual content. In an example, based on the first task-specific output for object detection and the second task-specific output for background segmentation, which identifies roads, landmarks, or obstacles in the foreground of the rendered visual content, the display 122 may overlay directional arrows or traffic alerts in real-time/near real-time on the rendered visual content. Various examples of the modification of the visual content are described in the foregoing description of FIG. 1. In various aspects, the display 122 can apply more than one type of modifications to the rendered visual content based on the first task-specific output and the second task-specific output.

In additional aspects, the processor(s) 102 may be individually or collectively configured to release the acquired first memory partition 202A and the acquired second memory partition 202B upon a completion of the execution of the second decoding model 104B, for example, at a time instance T₅. An execution time of the second decoding model 104B may be a difference of the time instances T₅ and T₄. In an example, the processor(s) 102 may transmit a request (e.g., [5] release (P1, P2)) to the execution memory 106 to release both the first memory partition 202A and the second memory partition 202B. Upon release, both the first memory partition 202A and the second memory partition 202B may become empty. In other words, the representation output 204 may remain stored in the first memory partition 202A till the set of decoding models (e.g., the first decoding model 104A and the second decoding model 104B) identified for the representation output 204 is executed, eliminating the involvement of main memory access to fetch representation output separately for each decoding model execution.

In more aspects, the decoding models 104 may have different priority levels. In a scenario where the identified set of decoding models include two decoding models or more than two decoding models, the set of decoding models may be executed in an order defined by the priority levels. For example, in the set of decoding models, the second decoding model 104B may have a lower priority than the first decoding model 104A. Thus, the processor(s) 102 may be individually or collectively configured to execute the second decoding model 104B after the execution of the first decoding model 104A based on the second decoding model 104B having the lower priority than the first decoding model 104A. In an example, the second task-specific output may depend on the first task-specific output. In such a scenario, the second decoding model 104B may have a lower priority than the first decoding model 104A due to a dependence on the execution of the first decoding model 104A. In an example scenario, the first task may be object identification and the second task may be object recognition of objects identified in the first task-specific output.

In an example scenario, the representation output 204 may correspond to a 1^{st} frame. In such a scenario, the processor(s) 102 may only identify the first decoding model 104A to be included as part of the set of decoding models based on the inference cadences of the first decoding model 104A and the second decoding model 104B. In such a scenario, the processor(s) 102 may be individually or collectively configured to release both the acquired first memory partition 202A and the second memory partition 202B upon a completion of the execution of the first decoding model 104A. In such a scenario, the requests transmitted at time instances T₄ and T₅ may be omitted

In various aspects, duration of an inference cycle for the multi-task device 100 may depend on the identified set of decoding models. For example, for the representation output 204 of the 0^{th} frame, for which both the first decoding model 104A and the second decoding model 104B are identified as part of the set of decoding models, the duration of the inference cycle may be a summation of respective execution times of the first decoding model 104A and the second decoding model 104B. However, for the representation output of the 1^{st} frame, for which only the first decoding model 104A is identified as part of the set of decoding models, the duration of the inference cycle may be the execution time of the first decoding model 104A.

FIG. 2B is a diagram of an example scenario 200B that illustrates changing availability statuses of memory partitions of the execution memory 106 in a multi-task inference cycle, in accordance with certain aspects of the present disclosure. FIG. 2B is described in conjunction with FIGS. 1 and 2A. The example scenario 200B is described with reference to the processor(s) 102 and the execution memory 106 of FIG. 1. In a non-limiting example, the execution memory 106 is shown to include two memory partitions such as the first memory partition 202A (labeled as “partition 202A” in FIG. 2B) and the second memory partition 202B (labeled as “partition 202B” in FIG. 2B).

In a variety of aspects, at the time instance T₀, availability statuses of both the first memory partition 202A and the second memory partition 202B may be unallocated. At a subsequent time instance T₁, based on the obtaining of the representation output 204 in the first memory partition 202A (e.g., [1] acquire (P1)), the availability status of the first memory partition 202A may change from unallocated to allocated, while the availability status of the second memory partition 202B may remain unallocated.

At the subsequent time instance T₂, based on the acquiring of the second memory partition 202B for the first decoding model 104A (e.g., [2] acquire and load (P2)), the availability status of the second memory partition 202B may change from unallocated to allocated. Since the first memory partition 202A already has the representation output 204 stored therein, at time instance T₂, availability statuses of both the first memory partition 202A and the second memory partition 202B may be allocated.

At the subsequent time instance T₃, based on the release of the second memory partition 202B upon the completion of the execution of the first decoding model 104A (e.g., [3] release (P2)), the availability status of the second memory partition 202B may change from allocated to unallocated, while the availability status of the first memory partition 202A may remain allocated.

At the subsequent time instance T₄, based on the acquiring of the second memory partition 202B for the second decoding model 104B (e.g., [4] acquire and load (P2)), the availability status of the second memory partition 202B may again change from unallocated to allocated. Thus, at time instance T₄, availability statuses of both the first memory partition 202A and the second memory partition 202B may be allocated.

At the subsequent time instance T₅, based on the release of the first memory partition 202A and the second memory partition 202B (e.g., [5] release (P1, P2)), upon the completion of the execution of the identified set of decoding models for the obtained representation output 204, the availability statuses of both the first memory partition 202A and the second memory partition 202B may change from allocated to unallocated.

In the multi-task inference cycle associated with the representation output 204, the availability status of the second memory partition 202B may change between allocated and unallocated as per acquisition and release of the second memory partition 202B for the set of decoding models identified for the representation output 204. However, as the representation output 204 may remain stored in the first memory partition 202A throughout the execution of the set of decoding models, the availability status of the first memory partition 202A may remain allocated till the set of decoding models are executed. Therefore, an involvement of main memory access to fetch representation output separately for each decoding model execution in the identified set of decoding models is eliminated.

In a scenario where the set of decoding models only includes the first decoding model 104A, upon a completion of the execution of the first decoding model 104A at the time instance T₂, both the first memory partition 202A and the second memory partition 202B may be released. In such a scenario, the availability statuses of both the first memory partition 202A and the second memory partition 202B may change from allocated to unallocated based on the completion of the execution of the first decoding model 104A.

In various aspects, the processor(s) 102 (for example, a scheduler 102F or a tracker 102G) may be individually or collectively configured to track the availability statuses of the plurality of memory partitions (e.g., the first memory partition 202A and the second memory partition 202B). For example, the processor(s) 102 may be configured to track the availability status of plurality of memory partitions through a combination of hardware and software mechanisms. The processor(s) 102 may maintain, for example, a status map for the execution memory 106 and update the availability statues in the status map as memory partitions are acquired or released for execution of the decoding models 104. In an example, the processor(s) 102 may maintain allocation tables, bitmaps, or linked lists that maintain a record of which memory partitions of the execution memory 106 are allocated and which are unallocated.

FIG. 2C is a diagram of an example scenario that illustrates a state transition diagram 200C for multi-task execution of AI models across different inference cycles, in accordance with certain aspects of the present disclosure. FIG. 2C is described in conjunction with FIGS. 1, 2A, and 2B. The example scenario is described with reference to the processor(s) 102 of FIG. 1. In a non-limiting example, the execution memory 106 may have two memory partitions such as an overmap segment (e.g., the first memory partition 202A and a non-overmap segment (e.g., the second memory partition 202B).

In various aspects, the processor(s) 102 (for example, a scheduler 102F and a tracker 102G) may dynamically transition between various operational states based on the tracking of the availability statuses of the plurality of memory partitions of the execution memory 106. Various operational states may include an unclaimed state 206, a claimed state 208, and a decoding state 210.

In an example, the processor(s) 102 may transition to the unclaimed state 206, based on the availability status of each of the first memory partition 202A and the second memory partition 202B being unallocated (indicated as overmap|non-overmap=0|0 in FIG. 2C). Thus, prior to the obtaining of the representation output 204 in the first memory partition 202A and the loading of the first decoding model 104A in the second memory partition 202B (e.g., at the time instance T₀ shown in FIGS. 2A and 2B), the processor(s) 102 may be in the unclaimed state 206.

In more examples, the processor(s) 102 may transition to the claimed state 208, based on the availability status of the first memory partition 202A being allocated and the availability status of the second memory partition 202B being unallocated (indicated as overmap|non-overmap=1|0 in FIG. 2C). Thus, upon the obtaining of the representation output 204 in the first memory partition 202A and prior to the loading of the first decoding model 104A or the second decoding model 104B in the second memory partition 202B (e.g., at the time instances T₁ and T₃ shown in FIGS. 2A and 2B), the processor(s) 102 may be in the claimed state 208.

In additional examples, the processor(s) 102 may transition to the decoding state 210, based on the availability status of each of the first memory partition 202A and the second memory partition 202B being allocated (indicated as overmap|non-overmap=1|1). Thus, upon the obtaining of the representation output 204 in the first memory partition 202A and the loading of the first decoding model 104A or the second decoding model 104B in the second memory partition 202B (e.g., at the time instances T₂ and T₄ shown in FIGS. 2A and 2B), the processor(s) 102 may be in the decoding state 210.

In many examples, from the decoding state 210, the processor(s) 102 can transition to any of the unclaimed state 206 or the claimed state 208 based on a change in the availability statuses of the first memory partition 202A and the second memory partition 202B. For example, upon a completion of the last decoding model in the identified set for the representation output 204, the processor(s) 102 can transition to the unclaimed state 206; however, if any decoding model 104 in the identified set is pending execution, the processor(s) 102 can transition to the claimed state 208 and then back to the decoding state 210 for the execution of the decoding model 104.

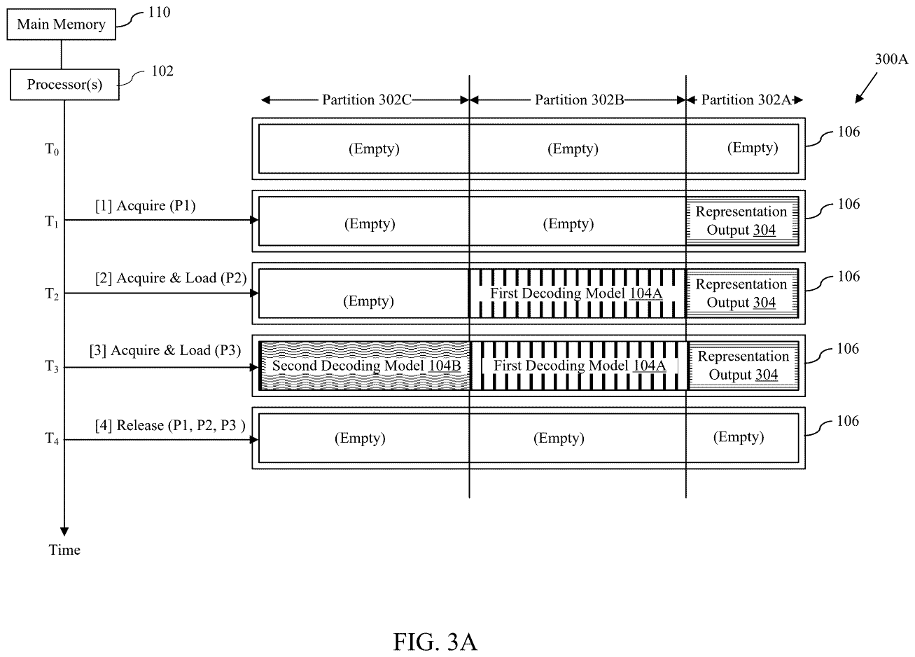

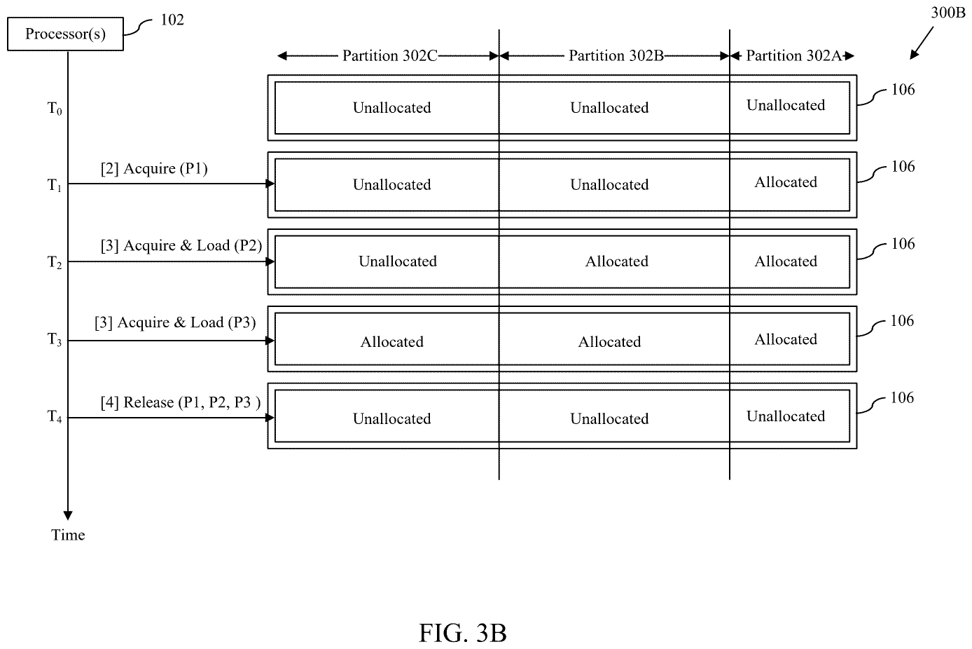

FIG. 3A is a diagram of an example scenario 300A that illustrates optimization of memory management for multi-task execution of AI models, in accordance with certain aspects of the present disclosure. FIG. 3A is described in conjunction with FIG. 1. The example scenario 300A is described with reference to the processor(s) 102, the first decoding model 104A, the second decoding model 104B, the execution memory 106, and the main memory 110 of FIG. 1. In a non-limiting example, the execution memory 106 is shown to include three memory partitions such as a first memory partition 302A (labeled as “partition 302A” in FIG. 3A), a second memory partition 302B (labeled as “partition 302B” in FIG. 3A), and a third memory partition 302C (labeled as “partition 302C” in FIG. 3A). In an example, a size of the first memory partition 302A may be smaller than the second memory partition 302B and the third memory partition 302C.

As shown in FIG. 3A, at a time instance T₀, the first memory partition 302A, the second memory partition 302B, and the third memory partition 302C may be empty. At a subsequent time instance T₁, the processor(s) 102 may obtain a representation output 304 in the first memory partition 302A. As shown in FIG. 3A, at time instance T₁, the first memory partition 302A has the representation output 304 obtained therein. For example, the processor(s) 102 may receive the representation output 304 and acquire the first memory partition 302A to store the received representation output 304. In an example, the processor(s) 102 may transmit a request (e.g., [1] acquire (P1)) to the execution memory 106 to acquire a specific size (e.g., the first memory partition 302A) of the execution memory 106 for storing the representation output 304.

In various aspects, prior to loading the second memory partition 302B and/or the third memory partition 302C with decoding model(s) 104, the processor(s) 102 may be individually or collectively configured to identify, among the decoding models 104, a set of decoding models to load in the execution memory 106 based on the respective inference cadences of the decoding models 104. Identification of the set of decoding models based on the respective inference cadences of the decoding models 104 is described in the foregoing description of FIG. 2A.

In a non-limiting example, the processor(s) 102 may identify both the first decoding model 104A and the second decoding model 104B to be included as part of the set of decoding models. Upon the identification of the set of decoding models, the processor(s) 102 may be configured to sequentially load the first decoding model 104A and the second decoding model 104B in the execution memory 106 for execution, while the representation output 304 may remain stored in the first memory partition 302A throughout the execution of the first decoding model 104A and the second decoding model 104B.

Continuing the above example, at a subsequent time instance T₂, the processor(s) 102 may be individually or collectively configured to acquire the second memory partition 302B for the first decoding model 104A and load the acquired second memory partition 302B with the first decoding model 104A from the main memory 110. In an example, the processor(s) 102 may transmit a request (e.g., [2] acquire and load (P2)) to the execution memory 106 to acquire the second memory partition 302B for loading the first decoding model 104A. At a subsequent or parallel time instance T₃, the processor(s) 102 may be individually or collectively configured to acquire the third memory partition 302C for the second decoding model 104B and load the acquired third memory partition 302C with the second decoding model 104B from the main memory 110. In an example, the processor(s) 102 may transmit a request (e.g., [3] acquire and load (P3)) to the execution memory 106 to acquire the third memory partition 302C for loading the second decoding model 104B.

Based on the loading of the first decoding model 104A in the second memory partition 302B and the loading of the second decoding model 104B in the third memory partition 302C, the processor(s) 102 may be individually or collectively configured to parallelly execute the first decoding model 104A and the second decoding model 104B based on the representation output 304 obtained in the first memory partition 302A.

In additional aspects, the processor(s) 102 may be individually or collectively configured to release the acquired second memory partition 302B upon a completion of the execution of the first decoding model 104A and the acquired third memory partition 302C upon a completion of the execution of the second decoding model 104B, for example, at a time instance T₄. In an example, the processor(s) 102 may transmit a request (e.g., [4] release (P1, P2, P3)) to the execution memory 106 to release the first memory partition 302A, the second memory partition 302B, and the third memory partition 302C. Upon release, the first memory partition 302A, the second memory partition 302B, and the third memory partition 302C may become empty.

In a non-limiting example, the processor(s) 102 may identify only the first decoding model 104A to be included as part of the set of decoding models. In such a scenario, the third memory partition 302C may remain unallocated for an inference cycle related to the representation output 304.

In various aspects, duration of an inference cycle for the multi-task device 100 may depend on the identified set of decoding models. For example, if for the representation output 304 both the first decoding model 104A and the second decoding model 104B are identified as part of the set of decoding models, the duration of the inference cycle may correspond to whichever is longer between the respective execution times of the first decoding model 104A and the second decoding model 104B. However, if for the representation output 304 only the first decoding model 104A is identified as part of the set of decoding models, the duration of the inference cycle may be the execution time of the first decoding model 104A.

FIG. 3B is a diagram of an example scenario 300B that illustrates changing availability statuses of memory partitions of the execution memory 106 in a multi-task inference cycle, in accordance with certain aspects of the present disclosure. FIG. 3B is described in conjunction with FIGS. 1 and 3A. The example scenario 300B is described with reference to the processor(s) 102 and the execution memory 106 of FIG. 1. In a non-limiting example, the execution memory 106 is shown to include three memory partitions such as the first memory partition 302A (labeled as “partition 302A” in FIG. 3B), the second memory partition 302B (labeled as “partition 302B” in FIG. 3B), and the third memory partition 302C (labeled as “partition 302C” in FIG. 3B.

In a variety of aspects, at the time instance T₀, availability statuses of the first memory partition 302A, the second memory partition 302B, and the third memory partition 302C may be unallocated. At a subsequent time instance T₁, based on the obtaining of the representation output 304 in the first memory partition 302A (e.g., [1] acquire (P1)), the availability status of the first memory partition 302A may change from unallocated to allocated, while the availability statuses of the second memory partition 302B and the third memory partition 302C may remain unallocated.

At the subsequent time instance T₂, based on the acquiring of the second memory partition 302B for the first decoding model 104A (e.g., [2] acquire and load (P2)), the availability status of the second memory partition 302B may change from unallocated to allocated. Thus, at time instance T₂, availability statuses of both the first memory partition 302A and the second memory partition 302B may be allocated. However, the availability status of the third memory partition 302C may remain unallocated.

At the subsequent time instance T₃, based on the acquiring of the third memory partition 302C for the second decoding model 104B (e.g., [3] acquire and load (P3)), the availability status of the third memory partition 302C may change from unallocated to allocated. Thus, at time instance T₃, availability statuses of the first memory partition 302A, the second memory partition 302B, and the third memory partition 302C may be allocated.

At the subsequent time instance T₄, based on the release of the first memory partition 302A, the second memory partition 302B, and the third memory partition 302C, upon the completion of the execution of the identified set of decoding models for the obtained representation output 304, the availability statuses of the first memory partition 302A, the second memory partition 302B, and the third memory partition 302C may change from allocated to unallocated. In various aspects, the processor(s) 102 may operate in accordance with the state transition diagram 200C illustrated in FIG. 2C without deviating from the scope of the disclosure.

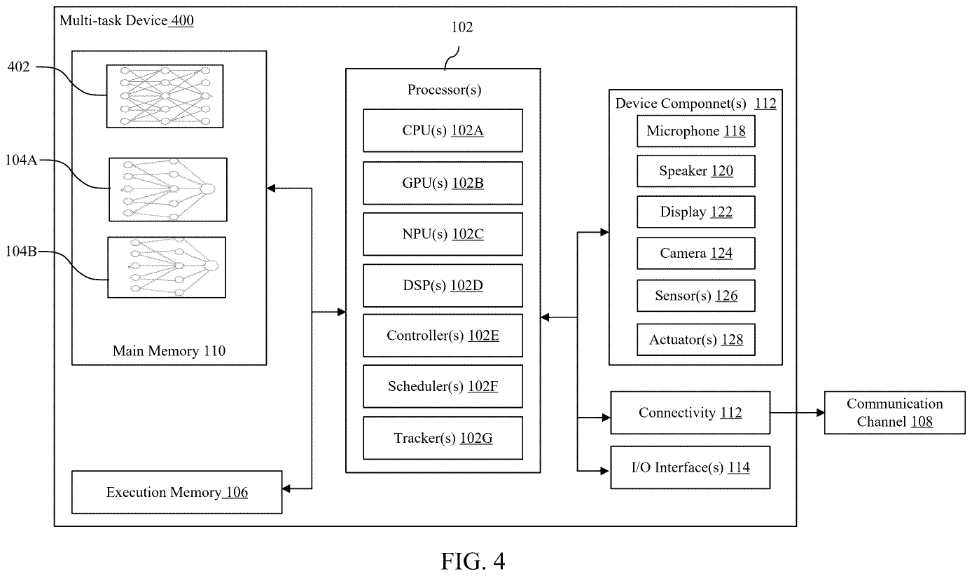

FIG. 4 is a diagram that illustrates an example of a multi-task device 400 that supports multi-task execution of AI models, in accordance with certain aspects of the present disclosure. FIG. 4 is described in conjunction with FIG. 1. The multi-task device 400 may include the processor(s) 102, the decoding models 104 (for example, including the first decoding model 104A and the second decoding model 104B), the execution memory 106, and the communication channel 108. In various aspects, the multi-task device 400 may additionally or optionally include the main memory 110, the device component(s) 112, the connectivity element 114, and the I/O interface(s) 116 as described in the foregoing description of FIG. 1. The device component(s) 112 may include, for example, the microphone 118, the speaker 120, the display 122, the camera 124, the sensor(s) 126, and the actuator(s) 128.

In various aspects, the multi-task device 400 may be similar to the multi-task device 100 of FIG. 1, except that the multi-task device 400 may additionally include an encoding model 402, for example, in the main memory 110. In various aspects, where the multi-task device 400 includes the encoding model 402 representation outputs may be generated locally at the multi-task device 400. In an example, the encoding model 402 can be implemented using any of the AI implementations as described in the foregoing description of FIG. 1.

In various aspects of multi-task execution, the encoding model 402 may be utilized to process input data and extract representation outputs from the input data. In an example, the input data can be images or frames of a video. The encoding model 402 may serve as a shared feature extractor that can generate a representation output which is subsequently utilized by the decoding models 104 for distinct downstream tasks. The representation output can be in the form of, for example, a feature map, an embedding, a latent vector, a compressed representation, or the like.

In an example, the input data can be received by the multi-task device 400 over the communication channel 108. Additionally or alternatively, the input data can be captured or generated by the multi-task device 400, for example, by utilizing the device component(s) 112. In an example, the input data can be single data modality (such as images or video frames) or multi-modality input (such as a video combined with audio, text, or sensor data). In a multimodal scenario, the encoding model 402 may be configured to integrate information from heterogeneous sources to generate a unified representation output, which captures cross-modal dependencies. For example, in a case where the multi-task device 400 is utilized for enabling autonomous driving, the encoding model 402 may process one or more video frames from the camera 124 while simultaneously incorporating sensor outputs generated by the sensor(s) 126.

In various aspects, the encoding model 402 may be decoupled (or isolated) from the decoding models 104. In such scenarios, the encoding model 402 can be operated at the highest inference cadence of the decoding models 104. For example, in video-based multi-task execution, if the first decoding model 104A performs high-frequency object identification while the second decoding model 104B operates at a lower inference cadence for scene light estimation, the encoding model 402 can be executed at the inference cadence of the object identification task. By decoupling the encoding model 402 from the decoding models 104 while maintaining the high inference cadence for the encoding model 402, the multi-task device 400 may enable optimized computational efficiency, improved feature sharing, and enhanced generalization across distinct multiple downstream tasks of the decoding models 104.

In various aspects, upon receiving or generating the input data, the processor(s) 102 may be configured to pre-process the input data. For example, pre-processing can include normalizing, resizing, or augmenting the input data. The processor(s) 102 may be individually or collectively configured to acquire the second memory partition of the execution memory 106 for the encoding model 402 based on the reception or the generation of the input data. In an example, the second memory partition may be larger than the first memory partition. In an example, based on the acquiring of the second memory partition, the processor(s) 102 may gain access to the second memory partition for real-time or near real-time execution. The processor(s) 102 may be individually or collectively configured to load the acquired second memory partition with the encoding model 402 and execute the loaded encoding model 402 based on the received or generated input data.

In an example, the encoding model 402, for execution, may apply one or more multi-purpose transformations on the input data and generate a representation output. In an example, by applying the multi-purpose transformations on the input data, the encoding model 402 may encode a variety of features associated with tasks of the decoding models 104 in the representation output. In an example, the encoding model 402 may apply a series of hierarchical transformations to extract the representation output from the input data. Examples of the transformations may include, but are not limited to, spatial feature extraction using convolutional layers, temporal modelling through recurrent or attention-based mechanisms, and dimensionality reduction to create a low-level representation output. Additionally or optionally, the transformations may include embedding projections and multimodal fusion when processing multi-modal input.

In various aspects, the processor(s) 102 may be configured to obtain the representation output generated by the encoding model 402 in the first memory partition without being routed through the main memory of the multi-task device 400. To obtain the representation output in the first memory partition, the processor(s) 102 may be configured to acquire the first memory partition to provide the representation output of the executed encoding model 402. In an example, acquisition of the first memory partition for providing the representation output can occur simultaneously with the acquisition of the second memory partition for the encoding model 402, for example, as an overmap for the encoding model 402. Further, upon a completion of the execution of the encoding model 402, the processor(s) 102 may be configured to release the second memory partition, which can then be utilized for the execution of the decoding models 104 as described in the forgoing description of FIG. 1.

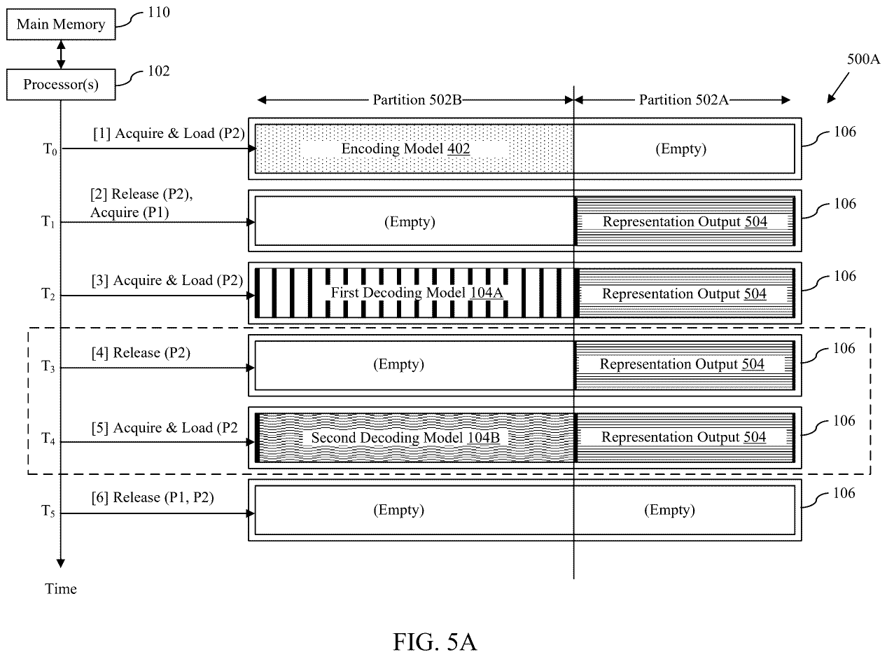

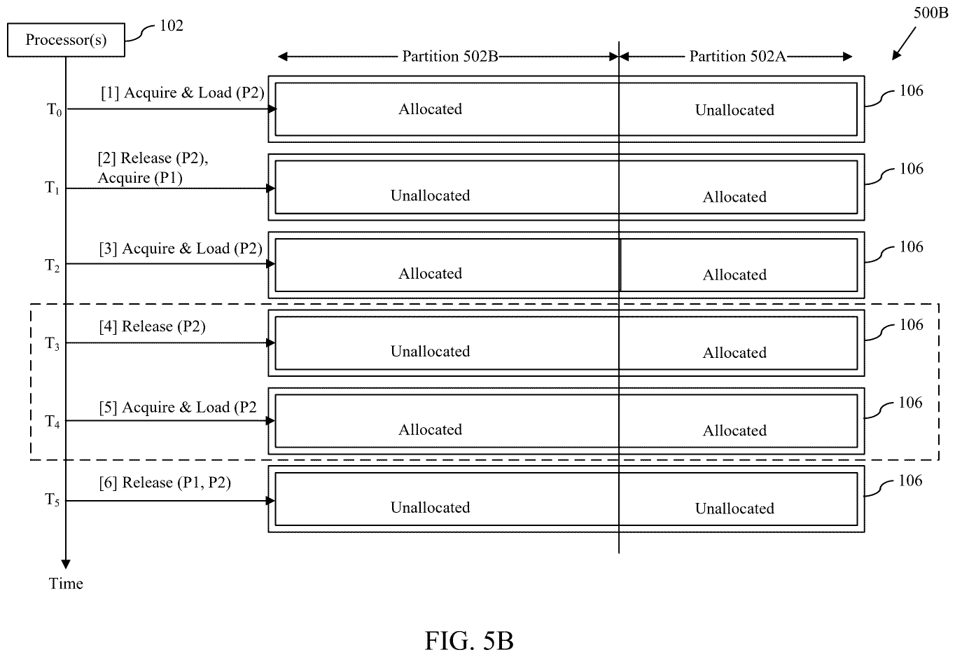

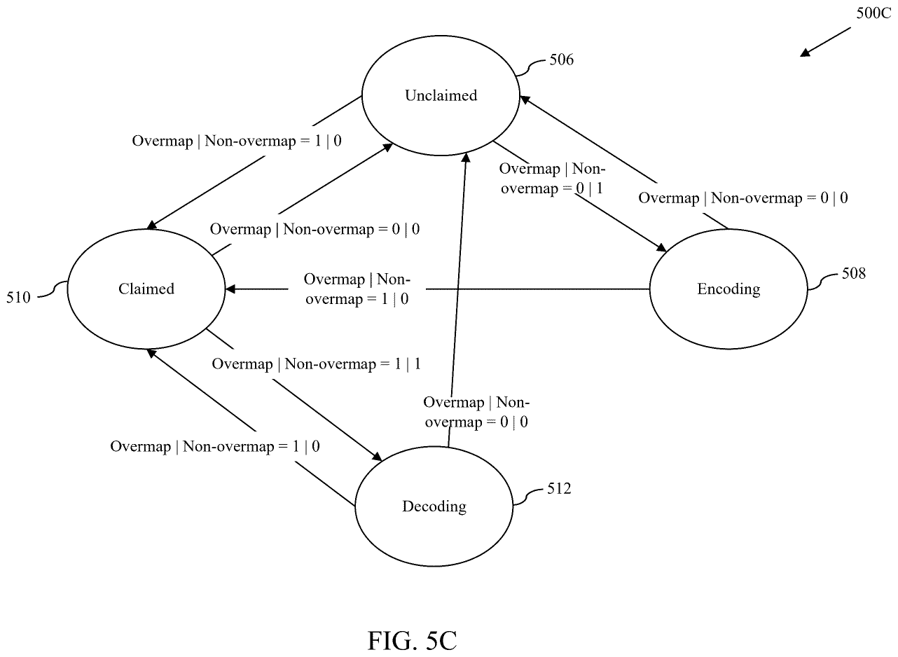

FIG. 5A is a diagram of an example scenario 500A that illustrates optimization of memory management for multi-task execution of AI models, in accordance with certain aspects of the present disclosure. FIG. 5A is described in conjunction with FIG. 1-4. The example scenario 500A is described with reference to the processor(s) 102, the first decoding model 104A, the second decoding model 104B, the encoding model 402, the execution memory 106, and the main memory 110 of FIG. 5. In a non-limiting example, the execution memory 106 is shown to include two memory partitions such as a first memory partition 502A (labeled as “partition 502A” in FIG. 5A) and a second memory partition 502B (labeled as “partition 502B” in FIG. 5A). In an example, a size of the first memory partition 502A may be smaller than the second memory partition 502B to allow execution of AI models (e.g., the first decoding model 104A, the second decoding model 104B, the encoding model 402).

As shown in FIG. 5A, at a time instance T₀, the processor(s) 102 may receive input data and transmit a request (e.g., [1] acquire and load (P2)) to acquire the second memory partition 502B to load the encoding model 402 from the main memory 110. In an example, the processor(s) 102 may transmit the request to acquire a specific size (e.g., the second memory partition 502B) of the execution memory 106 to load the encoding model 402. Based on the loading of the encoding model 402 in the second memory partition 502B, the processor(s) 102 may be individually or collectively configured to execute the encoding model 402. Execution of the encoding model 402 may include an application of the multi-purpose transformations on the input data and a generation of a representation output 504. In an example, the encoding model 402 may have a higher priority than any of the decoding models 104.

In various aspects, based on the generation of the representation output 504 and a completion of the execution of the encoding model 402 at a time instance T₁, the processor(s) 102 may be configured to transmit one or more requests (e.g., [2] release (P2) and acquire (P1)) to the execution memory 106 to release the second memory partition 502B and obtain the representation output 504 in the first memory partition 502A. Thus, at time instance T₁, the first memory partition 502A has the representation output 504 obtained therein, while the second memory partition 502B is freed or released.

In a variety of aspects, the decoding models 104 may be associated with respective inference cadences. For the sake of ongoing description and in a non-limiting example, it is assumed that the first decoding model 104A and the second decoding model 104B have different inference cadences, and the first decoding model 104A has the higher inference cadence between the first decoding model 104A and the second decoding model 104B. Further, the encoding model 402 is operated at the higher inference cadence between the respective inference cadences of the first decoding model 104A and the second decoding model 104B.

In various aspects, prior to loading the second memory partition 502B with a decoding model 104, the processor(s) 102 may be individually or collectively configured to identify, among the decoding models 104, a set of decoding models to load in the second memory partition 502B based on the respective inference cadences of the decoding models 104. In a non-limiting example scenario, it is identified that both the first decoding model 104A and the second decoding model 104B are to be included as part of the set of decoding models. Upon the identification of the set of decoding models, the processor(s) 102 may be configured to sequentially load the first decoding model 104A and the second decoding model 104B in the second memory partition 502B for execution while the representation output 504 may remain stored in the first memory partition 502A throughout the execution of the first decoding model 104A and the second decoding model 104b.

Thus, at a subsequent time instance T₂, the processor(s) 102 may be individually or collectively configured to acquire the second memory partition 502B for the first decoding model 104A based on the representation output 504 obtained in the first memory partition 502A and load the acquired second memory partition 502B with the first decoding model 104A from the main memory 110. In an example, the processor(s) 102 may transmit a request (e.g., [3] acquire and load (P2)) to the execution memory 106 to acquire the second memory partition 502B and load the first decoding model 104A. Based on the loading of the first decoding model 104A in the second memory partition 502B, the processor(s) 102 may be individually or collectively configured to execute the first decoding model 104A based on the representation output 504.

In additional aspects, the processor(s) 102 may be individually or collectively configured to release the acquired second memory partition 502B upon a completion of the execution of the first decoding model 104A, for example, at a time instance T₃. In an example, the processor(s) 102 may transmit a request (e.g., [4] release (P2)) to the execution memory 106 to release the second memory partition 502B. Upon release, the second memory partition 502B may again become empty.

Based on the release of the second memory partition 502B, at a subsequent time instance T₄, the processor(s) 102 may be individually or collectively configured to acquire the second memory partition 502B for the second decoding model 104B in the identified set and load the acquired second memory partition 502B with the second decoding model 104B from the main memory 110. In an example, the processor(s) 102 may transmit a request (e.g., [5] acquire and load (P2)) to the execution memory 106 to acquire the second memory partition 502B for loading the second decoding model 104B. Based on the loading of the second decoding model 104B in the second memory partition 502B, the processor(s) 102 may be individually or collectively configured to execute the second decoding model 104B based on the representation output 504.

In additional aspects, the processor(s) 102 may be individually or collectively configured to release the acquired first memory partition 502A and the acquired second memory partition 502B upon a completion of the execution of the second decoding model 104B, for example, at a time instance T₅. In an example, the processor(s) 102 may transmit a request (e.g., [6] release (P1, P2)) to the execution memory 106 to release both the first memory partition 502A and the second memory partition 502B. Upon release, both the first memory partition 502A and the second memory partition 502B may become empty. In other words, the representation output 504 may remain stored in the first memory partition 502A till the set of decoding models (e.g., the first decoding model 104A and the second decoding model 104B) identified for the representation output 504 is executed. In various aspects, the processor(s) 102 may be individually or collectively configured to execute the second decoding model 104B after the execution of the first decoding model 104A based on the second decoding model 104B having a lower priority than the first decoding model 104A.

In an example scenario, the processor(s) 102 may only identify the first decoding model 104A to be included as part of the set of decoding models based on the inference cadences of the first decoding model 104A and the second decoding model 104B. In such a scenario, the processor(s) 102 may be individually or collectively configured to release both the acquired first memory partition 502A and the second memory partition 502B upon a completion of the execution of the first decoding model 104A.

FIG. 5B is a diagram of an example scenario 500B that illustrates changing availability statuses of memory partitions of the execution memory 106 in a multi-task inference cycle, in accordance with certain aspects of the present disclosure. FIG. 5B is described in conjunction with FIG. 1-5A. The example scenario 500B is described with reference to the processor(s) 102 and the execution memory 106 of FIGS. 1 and 4. In a non-limiting example, the execution memory 106 is shown to include two memory partitions such as the first memory partition 502A (labeled as “partition 502A” in FIG. 5B) and the second memory partition 502B (labeled as “partition 502B” in FIG. 5B).

In a variety of aspects, at the time instance T₀, based on the acquiring of the second memory partition 502B for the encoding model 402, an availability status of the first memory partition 502A may be unallocated and an availability status of the second memory partition 502B may be allocated. At the time instance T₁, availability status of the first memory partition 502A may change from unallocated to allocated based on the obtaining of the representation output 504 in the first memory partition 502A (e.g., [2] acquire (P1)), and availability status of the second memory partition 502B may change from allocated to unallocated based on the release of the second memory partition 502B (e.g., [2] release (P2)), upon the completion of the execution of the encoding model 402.

At a subsequent time instance T₂, based on the acquiring of the second memory partition 502B for the first decoding model 104A (e.g., [3] acquire and load (P2)), the availability status of the second memory partition 502B may change from unallocated to allocated. Thus, at time instance T₂, availability statuses of both the first memory partition 502A and the second memory partition 502B may be allocated.

At the subsequent time instance T₃, based on the release of the second memory partition 502B upon the completion of the execution of the first decoding model 104A (e.g., [4] release (P2)), the availability status of the second memory partition 502B may change from allocated to unallocated, while the availability status of the first memory partition 502A remains allocated.

At the subsequent time instance T₄, based on the acquiring of the second memory partition 502B for the second decoding model 104B (e.g., [5] acquire and load (P2)), the availability status of the second memory partition 502B may again change from unallocated to allocated. Thus, at time instance T₄, availability statuses of both the first memory partition 502A and the second memory partition 502B may be allocated.

At the subsequent time instance T₅, based on the release of the first memory partition 502A and the second memory partition 502B (e.g., [6] release (P1, P2)), upon the completion of the execution of the identified set of decoding models for the obtained representation output 504, the availability statuses of both the first memory partition 502A and the second memory partition 502B may change from allocated to unallocated.

In the multi-task inference cycle associated with the representation output 504 generated by the encoding model 402, the availability status of the first memory partition 502A may remain allocated till the set of decoding models is executed. Therefore, an involvement of main memory access to fetch representation output separately for each decoding model execution in the identified set of decoding models is eliminated.

In a scenario where the set of decoding models only includes the first decoding model 104A, upon a completion of the execution of the first decoding model 104A at the time instance T₂, both the first memory partition 502A and the second memory partition 502B may be released. In such a scenario, the availability statuses of both the first memory partition 502A and the second memory partition 502B may change from allocated to unallocated based on the completion of the execution of the first decoding model 104A.

In various aspects, the processor(s) 102 (for example, a scheduler 102F or a tracker 102G) may be individually or collectively configured to track the availability statuses of the plurality of memory partitions (e.g., the first memory partition 502A and the second memory partition 502B) as described in the foregoing description of FIG. 2B.

FIG. 5C is a diagram of an example scenario 500C that illustrates a state transition diagram for multi-task execution of AI models across different inference cycles, in accordance with certain aspects of the present disclosure. FIG. 5C is described in conjunction with FIG. 1-5B. The example scenario 500C is described with reference to the processor(s) 102 of FIGS. 1 and 4. In a non-limiting example, the execution memory 106 may have two memory partitions such as an overmap segment (e.g., the first memory partition 502A and a non-overmap segment (e.g., the second memory partition 502B).

In various aspects, the processor(s) 102 (for example, a scheduler 102F and a tracker 102G) may dynamically transition between various operational states based on a tracking of the availability statuses of the plurality of memory partitions of the execution memory 106. Various operational states may include an unclaimed state 506, an encoding state 508, a claimed state 510, and a decoding state 512.

In an example, the processor(s) 102 may transition to the unclaimed state 506, based on the availability status of each of the first memory partition 502A and the second memory partition 502B being unallocated (indicated as overmap|non-overmap=0|0 in FIG. 5C). Thus, prior to execution of the encoding model 402 (e.g., prior to the time instance T₀ shown in FIGS. 5A and 5B), the processor(s) 102 may be in the unclaimed state 506.

In more examples, the processor(s) 102 may transition to the encoding state 508, based on the availability status of the first memory partition 502A being unallocated and the availability status of the second memory partition 502B being allocated (indicated as overmap|non-overmap=0|1 in FIG. 5C). Thus, upon the acquiring of the second memory partition 502B and prior to the obtaining of the representation output 504 in the first memory partition 502A (e.g., at the time instance T₀ shown in FIGS. 5A and 5B), the processor(s) 102 may be in the encoding state 508.

In more examples, the processor(s) 102 may transition to the claimed state 510, based on the availability status of the first memory partition 502A being allocated and the availability status of the second memory partition 502B being unallocated (indicated as overmap|non-overmap=1|0 in FIG. 5C). Thus, upon the obtaining of the representation output 504 in the first memory partition 502A and prior to the loading of the first decoding model 104A or the second decoding model 104B in the second memory partition 502B (e.g., at the time instances T₁ and T₃ shown in FIGS. 5A and 5B), the processor(s) 102 may be in the claimed state 510.

In additional examples, the processor(s) 102 may transition to the decoding state 512, based on the availability status of each of the first memory partition 502A and the second memory partition 502B being allocated (indicated as overmap|non-overmap=1|1). Thus, upon the obtaining of the representation output 504 in the first memory partition 502A and the loading of the first decoding model 104A or the second decoding model 104B in the second memory partition 502B (e.g., at the time instances T₂ and T₄ shown in FIGS. 5A and 5B), the processor(s) 102 may be in the decoding state 512.

In many examples, from the encoding state 508, the processor(s) 102 can transition to any of the unclaimed state 506 or the claimed state 510 based on a change in the availability status of the first memory partition 502A and the second memory partition 502B. In many examples, from the decoding state 512, the processor(s) 102 can transition to any of the unclaimed state 506 or the claimed state 510 based on a change in the availability status of the first memory partition 502A and the second memory partition 502B. For example, upon a completion of the last decoding model in an identified set for the representation output 504, the processor(s) 102 can transition to the unclaimed state 506; however, if any decoding model 104 in an identified set is pending execution, the processor(s) 102 can transition to the claimed state 510 and then back to the decoding state 512 for the execution of the decoding model 104.

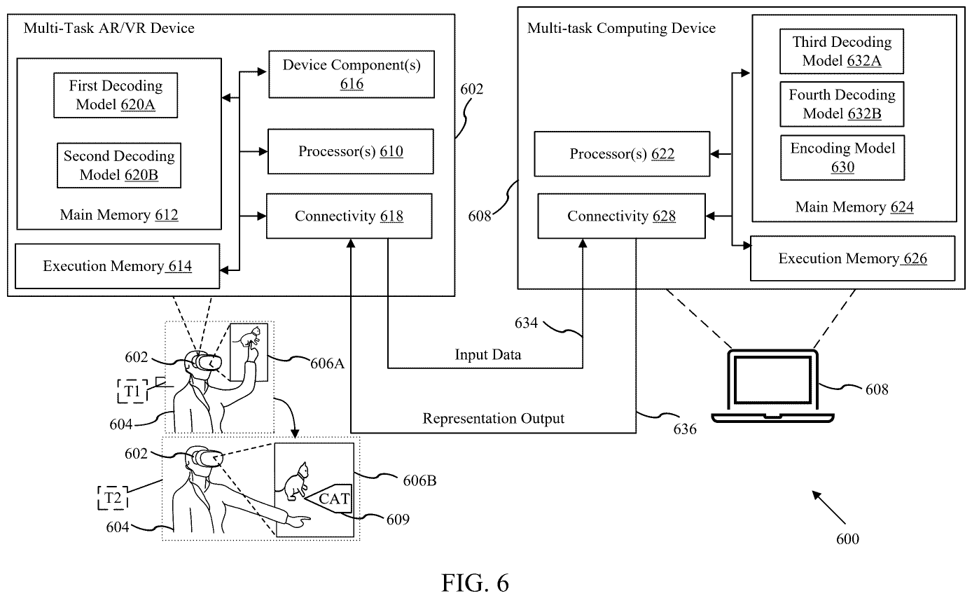

FIG. 6 is a diagram of an example scenario 600 that illustrates multi-task execution of AI models in a split rendering mode, in accordance with certain aspects of the present disclosure. FIG. 6 is described in conjunction with FIG. 1-5C. In a non-limiting example, the example scenario 600 illustrates a multi-task XR device 602 worn by a user 604 (e.g., as a head-mount display).

In various aspects, XR technologies can be utilized to present virtual content to users, and/or can combine real environments from the physical world and virtual environments to provide users with extended reality experiences. The term extended reality can encompass virtual reality (VR), augmented reality (AR), mixed reality (MR), and the like. XR systems can allow users to experience extended reality environments by overlaying virtual content onto images of a real-world environment, which can be viewed by a user through an extended reality device such as the multi-task XR device 602 (e.g., a head-mounted display, extended reality glasses, or any such device). The real-world environment can include physical objects, people, or other real world objects. XR technology can be implemented in various applications and fields, including entertainment (e.g., gaming), room designing and/or virtual shopping, food/health monitoring, video calling, teleconferencing, and education, among other applications and fields.

In a non-limiting example, the multi-task XR device 602 is shown to present visual content 606A to the user 604 at a time instance T1. In an example, the multi-task XR device 602 may be communicatively coupled to a multi-task computing device 608. The multi-task computing device 608 may be a laptop or a gaming console communicatively paired with the multi-task XR device 602.

In an example, the multi-task XR device 602 may include processor(s) 610, a main memory 612, an execution memory 614, device component(s) 616 (e.g., a camera and a display), and a connectivity element 618. In an example, the multi-task XR device 602 may be similar to the multi-task device 100 of FIG. 1. In such a scenario, the processor(s) 610 may be similar to the processor(s) 102, the main memory 612 may be similar to the main memory 110, the execution memory 614 may be similar to the execution memory 106, and the connectivity element 618 may be similar to the connectivity element 114. The main memory 612 may be configured to store a first decoding model 620A and a second decoding model 620B which may be similar to the decoding models 104 of FIG. 1.

In an example, the multi-task computing device 608 may include processor(s) 622, a main memory 624, an execution memory 626, and a connectivity element 628. In an example, the multi-task computing device 608 may be similar to the multi-task device 400 of FIG. 4. In such a scenario, the processor(s) 622 may be similar to the processor(s) 102, the main memory 624 may be similar to the main memory 110, the execution memory 626 may be similar to the execution memory 106, and the connectivity element 628 may be similar to the connectivity element 114 of the multi-task device 400. The main memory 624 may be configured to store an encoding model 630, a third decoding model 632A, and a fourth decoding model 632B.

In an example scenario, in the split rendering mode, computational workloads can be distributed between various devices, such as the multi-task computing device 608 and the multi-task XR device 602, to balance efficiency, latency, and power consumption. The encoding model 630 may be executed on the multi-task computing device 608, which has greater processing capabilities, while task-specific decoding models (e.g., the first decoding model 620A and the second decoding model 620B) may be executed on the multi-task XR device 602. At the time instance T1, the multi-task XR device 602 may capture input data 634 (such as a camera frame) and transmit the input data 634 to the multi-task computing device 608. The multi-task computing device 608 may process the input data 634 using the encoding model 630, for example, applying feature extraction and transformation operations to generate a representation output 636. This representation output 636 may be transmitted to the multi-task XR device 602, where the first decoding model 620A and/or the second decoding model 620B utilize the representation output 636 to perform tasks such as object identification and gesture recognition, respectively. The representation output 636 may be obtained in one memory partition of the execution memory 614, while the first decoding model 620A and/or the second decoding model 620B may be executed based on the representation output 636 utilizing remaining memory partitions of the execution memory 614 (as described in the foregoing description of FIG. 1-5C) as per their respective cadences.

In the example scenario 600, the input data 634 (e.g., an image frame) may be indicative of the user 604 performing a hand gesture to point at an object displayed in the visual content 606A. Based on the representation output 636 generated for the input data 634, the executed first decoding model 620A may identify the hand and the executed second decoding model 620B may recognize the hand gesture of the user 604. Based on task-specific outputs generated by the executed first decoding model 620A and the executed second decoding model 620B, the display of the multi-task XR device 602 may modify the rendered visual content 606A. At time instance T2, the modified visual content 606B presents an overlaid information cue 609 at a position which the user 604 pointed. As illustrated in FIG. 6, the information cue 609 appears as a label reading “CAT,” overlaid on a cat-shaped object that aligns with the pointed location in the original visual content 606A by the user 604. The modified visual content 606B rendered by the display of the multi-task XR device 602 at time instance T2 may present an overlaid information cue 609 corresponding to a position on the rendered visual content 606A where the user 604 had pointed out using the hand. For example, as shown in FIG. 6, the overlaid information cue 609 is a label “CAT” overlaid on a cat shaped object that coincides with the position on the rendered visual content 606A which the user 604 had pointed out using the hand. The first decoding model 620A and the second decoding model 620B can be selected for execution based on their respective inference cadences.

In a scenario, if the multi-task XR device 602 experiences low power levels, the execution of the first decoding model 620A and the second decoding model 620B can be offloaded to the multi-task computing device 608, reducing the power demand on the multi-task XR device 602. In such a scenario instead of receiving the representation output 636 from the multi-task computing device 608, the multi-task XR device 602 may receive a control signal. The processor(s) 610 may control an operation of the display based on the control signal, such as to present the overlaid information cue 609 corresponding to the position on the rendered visual content 606A where the user 604 had pointed out using the hand.

Additionally, executing AI models (e.g., the encoding model 630, the first decoding model 620A, and the second decoding model 620B) in a split rendering mode/split mode, where the encoding model 630 and the first decoding model 620A and the second decoding model 620B run separately, may allow for seamless addition of new decoding models via over-the-air (OTA) updates. Such an approach may enable dynamic expansion of decoding capabilities of the multi-task XR device 602, where the processor(s) 610 can be updated to integrate newly added decoding models without disrupting operations of the existing decoding models.

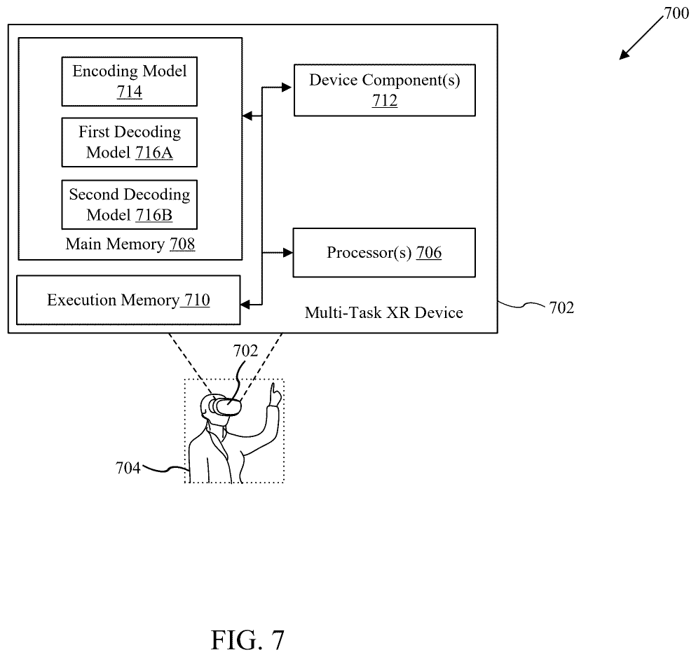

FIG. 7 is a diagram of an example scenario 700 that illustrates multi-task execution of AI models, in accordance with certain aspects of the present disclosure. FIG. 7 is described in conjunction with FIG. 1-5C. In a non-limiting example, the example scenario 700 illustrates a multi-task XR device 702 worn by a user 704 (e.g., as a head-mount display). The multi-task XR device 702 may be configured to present visual content to the user 704. In an example, the multi-task XR device 702 may include processor(s) 706, a main memory 708, an execution memory 710, and device component(s) 712 (e.g., a camera and a display). In an example, the multi-task XR device 702 may be similar to the multi-task device 400 of FIG. 4. In such a scenario, the processor(s) 706 may be similar to the processor(s) 102, the main memory 708 may be similar to the main memory 110, the execution memory 710 may be similar to the execution memory 106 of the multi-task device 400 of FIG. 4. The main memory 708 may be configured to store an encoding model 714, a first decoding model 716A, and a second decoding model 716B.

In an example scenario, the encoding model 714 and task-specific decoding models (e.g., the first decoding model 716A and the second decoding model 716B) may be executed on the multi-task XR device 702 by utilizing the memory sharing feature of the execution memory 710 as described in the foregoing description of FIG. 1-5C.

The multi-task XR device 702 may capture input data (such as a camera frame) and process the input data using the encoding model 714, for example, applying feature extraction and transformation operations to generate a representation output. This representation output may be utilized by the first decoding model 716A and/or the second decoding model 716B to perform tasks such as object detection, background segmentation, human depth estimation, scene segmentation, scene light estimation, object tracking, gesture recognition, gaze tracking, pose estimation, or the like. The representation output may be obtained in one memory partition of the execution memory 710, and the first decoding model 716A and/or the second decoding model 716B may be executed based on the representation output utilizing remaining memory partitions of the execution memory 710 (as described in the foregoing description of FIG. 1-5C) as per their respective cadences.

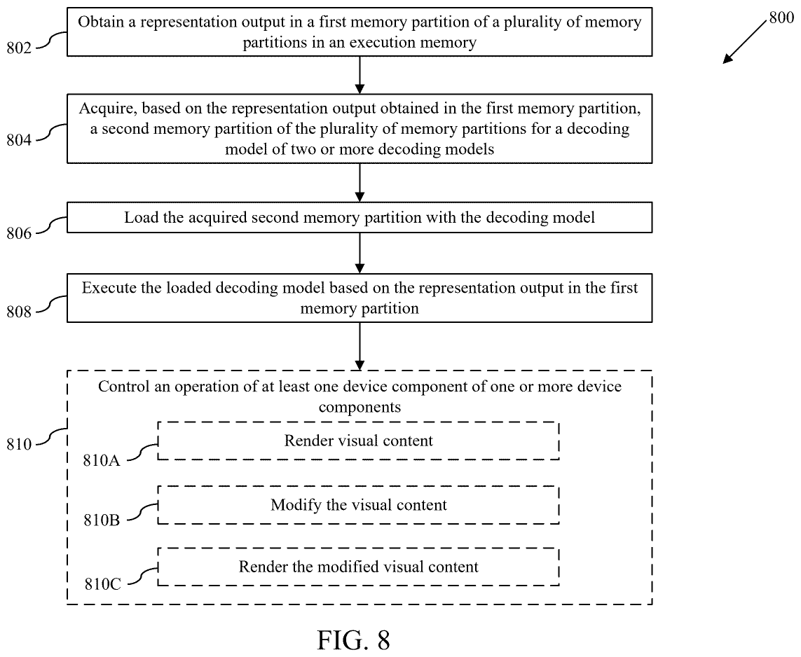

FIG. 8 is a high-level flowchart that illustrates a method (e.g., a process) executed at a device to optimize multi-task execution of AI models, in accordance with certain aspects of the present disclosure. In many examples, the device can be the multi-task device 100, the multi-task device 400, the multi-task XR device 602, 702, or the multi-task computing device 608 described in the foregoing description of FIG. 1-7. Referring to FIG. 8, there is shown a flowchart 800 that illustrates example operations 802 through 810 for optimizing multi-task execution of AI models. In a non-limiting example, the flowchart 800 is explained with reference to the multi-task device 100 of FIG. 1-2C.

At 802, a representation output is obtained in a first memory partition of a plurality of memory partitions in an execution memory. For example, the processor(s) 102 may be configured to obtain the representation output 204 in the first memory partition 202A of the execution memory 106.

At 804, based on the representation output obtained in the first memory partition, a second memory partition of the plurality of memory partitions is acquired for a decoding model of two or more decoding models. For example, the processor(s) 102 may be configured to acquire the second memory partition 202B for the first decoding model 104A based on the representation output 204 obtained in the first memory partition 202A.

At 806, the acquired second memory partition is loaded with the decoding model. For example, the processor(s) 102 may be configured to load the acquired second memory partition 202B with the first decoding model 104A.

At 808, the loaded decoding model is executed based on the representation output in the first memory partition. For example, the processor(s) 102 may be configured to execute the loaded first decoding model 104A based on the representation output 204 in the first memory partition 202A.

At 810, an operation of at least one device component of one or more device components is controlled. For example, the processor(s) 102 may be configured to control an operation of at least one of the device component(s) 112. In an example, the at least one device component includes the display 122. In an example, example operations 810A through 810C for controlling the operation of the display 122 are shown in FIG. 8. In an example, the operations 810A through 810C may be optional.

At 810A, visual content is rendered. At 810B, the visual content is modified, and at 810C, the modified visual content is rendered. For examples, based on the control of the operation, the display 122 may be configured to render the visual content, modify the visual content, and render the modified visual content. The modification of the visual content may include at least one of an overlay of one or more information cues on the rendered visual content, an adjustment of at least one visual property of the rendered visual content, or a reconfiguration of the rendered visual content as described in the foregoing description of FIG. 1. In various aspects, the control of the operation of the at least one of the device component(s) 112 may be optional.

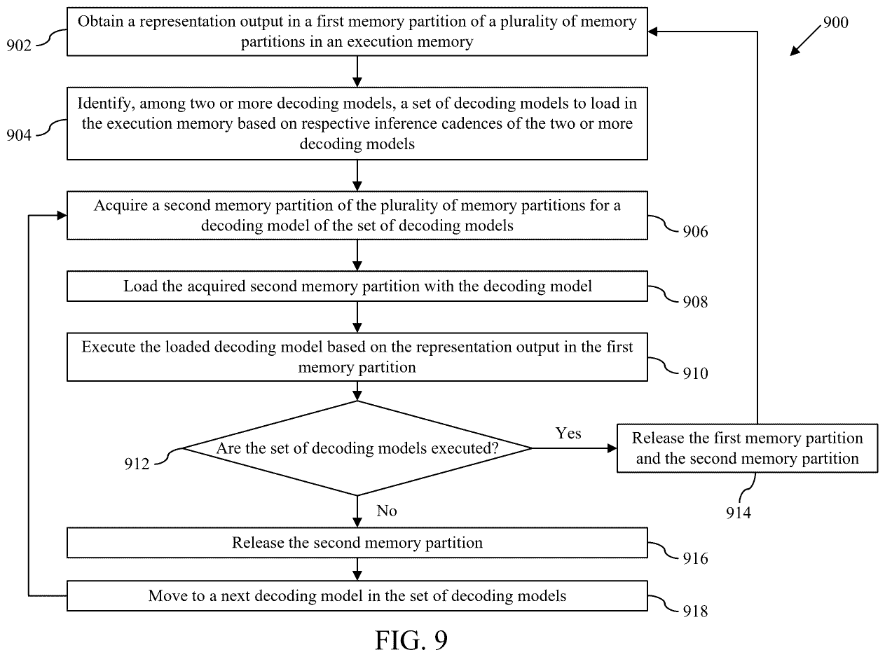

FIG. 9 is a detailed flowchart that illustrates a method (e.g., a process) executed at a device to optimize memory management for multi-task execution of AI models, in accordance with certain aspects of the present disclosure. In many examples, the device can be the multi-task device 100, the multi-task device 400, the multi-task XR device 602, 702, or the multi-task computing device 608 described in the foregoing description of FIG. 1-7. Referring to FIG. 9 there is shown a flowchart 900 that illustrates example operations 902 through 918 for optimizing multi-task execution of AI models. In a non-limiting example, the flowchart 900 is explained with reference to the multi-task device 100 of FIG. 1-2C.

At 902, a representation output in a first memory partition of a plurality of memory partitions in an execution memory is obtained. For example, the processor(s) 102 may be configured to obtain the representation output 204 in the first memory partition 202A in the execution memory 106.

At 904, among two or more decoding models, a set of decoding models to load in the execution memory is identified based on respective inference cadences of the two or more decoding models. For example, the processor(s) 102 may be configured to identify, among the decoding models 104, a set of decoding models to load in the execution memory 106 based on respective inference cadences of the decoding models 104.

At 906, a second memory partition of the plurality of memory partitions is acquired for a decoding model of the set of decoding models. For example, the processor(s) 102 may be configured to acquire the second memory partition 202B for the first decoding model 104A in the set of decoding models. In an example, the first decoding model 104A may have the highest priority level in the set of decoding models. In an example, the set of decoding models may have different priority levels, and thus may be executed in an order defined by the priority levels. For example, in the set of decoding models, the second decoding model 104B may have a lower priority than the first decoding model 104A. Thus, the second decoding model 104B may be executed after the first decoding model 104A.

At 908, the acquired second memory partition is loaded with the decoding model. For example, the processor(s) 102 may be configured to load the first decoding model 104A in the second memory partition 202B.

At 910, the loaded decoding model is executed based on the representation output in the first memory partition. For example, the processor(s) 102 may be configured to execute the loaded first decoding model 104A based on the representation output 204 in the first memory partition 202A. The execution of the first decoding model 104A may include application of one or more task-specification transformations for a task associated with the first decoding model 104A and generate a task-specific output for the task.

At 912, the processor(s) 102 may determine whether the set of decoding models is executed. For example, if at least one decoding model of the set of decoding models is pending execution, the processor(s) 102 may determine that the set of decoding models is yet not executed. Thus, if at 912, the processor(s) 102 determine that the set of decoding models is executed, control may pass to 914.

At 914, the first memory partition and the second memory partition are released. For example, the processor(s) 102 may be configured to release both the first memory partition 202A and the second memory partition 202B, and control may pass to 902 to process a subsequent representation output.

However, if at 912, the processor(s) 102 determine that the set of decoding models is yet to be executed, control may pass to 916. At 916, the second memory partition is released. For example, the processor(s) 102 may be configured to release the second memory partition 202B, while still having the representation output in the first memory partition 202A for subsequent decoding model execution.

At 918, the processor(s) 102 may move to a next decoding model in the set of decoding models. For example, the processor(s) 102 may move to a next decoding model in the set of decoding models that is pending execution for the representation output 204 currently obtained in the first memory partition 202A, and the control may pass to 906.

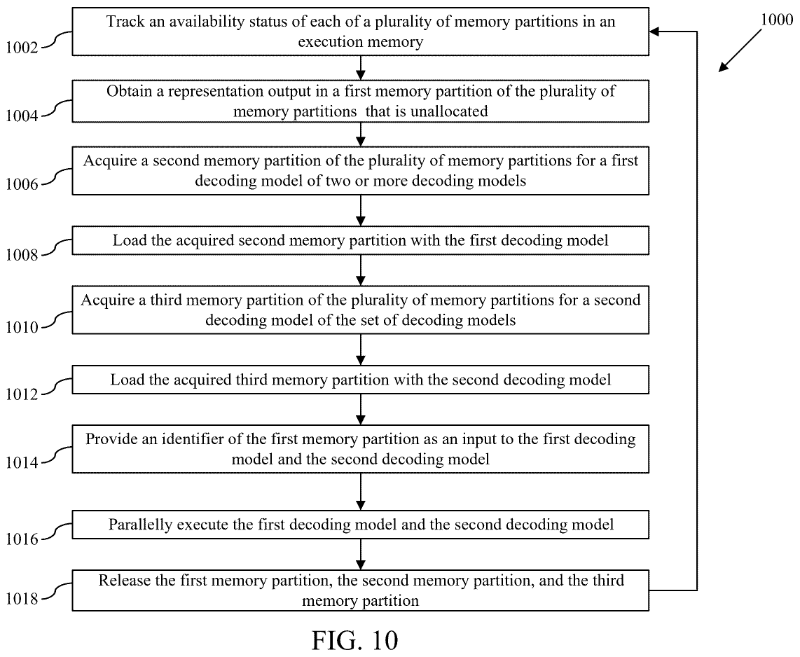

FIG. 10 is a detailed flowchart that illustrates a method (e.g., a process) executed at a device to optimize multi-task execution of AI models, in accordance with certain aspects of the present disclosure. In many examples, the device can be the multi-task device 100, the multi-task device 400, the multi-task XR device 602, 702, or the multi-task computing device 608 described in the foregoing description of FIG. 1-7. Referring to FIG. 10, there is shown a flowchart 1000 that illustrates example operations 1002 through 1018 for optimizing multi-task execution of AI models. In a non-limiting example, the flowchart 1000 is explained with reference to the multi-task device 100 of FIGS. 1, 3A, and 3B.

At 1002, an availability status of each of a plurality of memory partitions in an execution memory is tracked. For example, the processor(s) 102 may be configured to track the availability statuses of the plurality of memory partitions in the execution memory 106. An availability status can be allocated or unallocated.

At 1004, a representation output is obtained in a first memory partition of the plurality of memory partitions that is unallocated. For example, the processor(s) 102 may be configured to obtain the representation output 304 in the first memory partition 302A in the execution memory 106 whose availability status is unallocated. In an example, the first memory partition 302A in which the representation output 304 is obtained may correspond to an overmap segment in the execution memory 106.

At 1006, a second memory partition of the plurality of memory partitions is acquired for a first decoding model of two or more decoding models. For example, the processor(s) 102 may be configured to acquire the second memory partition 302B, which was unallocated, for the first decoding model 104A.

At 1008, the acquired second memory partition is loaded with the first decoding model. For example, the processor(s) 102 may be configured to load the first decoding model 104A in the second memory partition 302B.

At 1010, a third memory partition of the plurality of memory partitions is acquired for a second decoding model of the two or more decoding models. For example, the processor(s) 102 may be configured to acquire the third memory partition 302C, which was unallocated, for the second decoding model 104B.

At 1012, the acquired third memory partition is loaded with the second decoding model. For example, the processor(s) 102 may be configured to load the second decoding model 104B in the third memory partition 302C.

At 1014, an identifier of the first memory partition is provided as an input to the first decoding model and the second decoding model. For example, the processor(s) 102 may be configured to provide the identifier of the first memory partition 302A as an input to the first decoding model 104A and the second decoding model 104B.

At 1016, the first decoding model and the second decoding model are parallelly executed. For example, the processor(s) 102 may be configured to execute the first decoding model 104A and the second decoding model 104B based on the representation output 304 in the first memory partition 302A.

At 1018, the first memory partition, the second memory partition, and the third memory partition are released. For example, the processor(s) 102 may be configured to release the first memory partition 302A, the second memory partition 302B, and the third memory partition 302C upon completion of the execution of the first decoding model 104A and the second decoding model 104B based on the representation output 304 in the first memory partition 302A. In further examples, the processor(s) 102 may be configured to release the first memory partition 302A, the second memory partition 302B, and the third memory partition 302C upon completion of the execution of the first decoding model 104A or the second decoding model 104B, whichever takes longer.

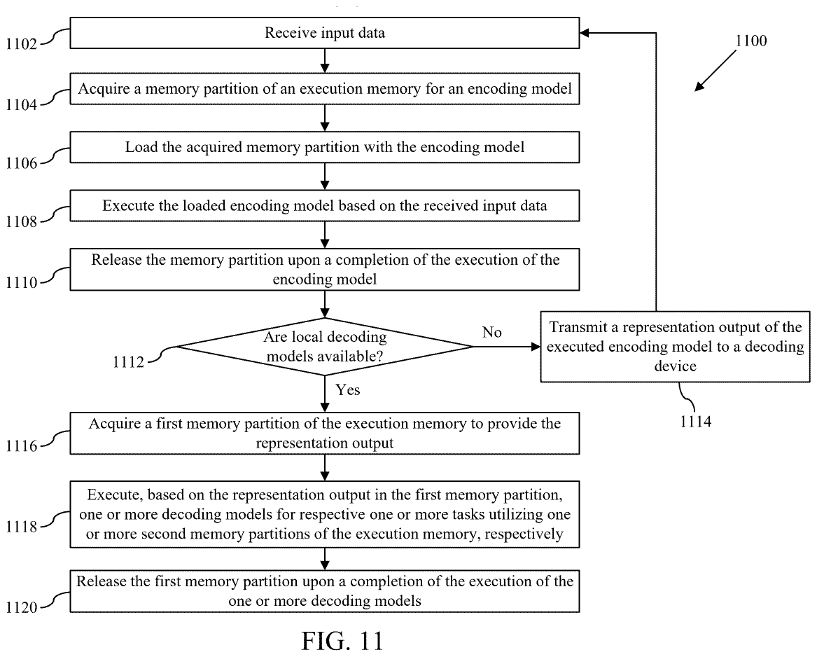

FIG. 11 is a detailed flowchart that illustrates a method (e.g., a process) executed at a device to optimize multi-task execution of AI models, in accordance with certain aspects of the present disclosure. In many examples, the device can be the multi-task device 400, the multi-task XR device 702, or the multi-task computing device 608 described in the foregoing description of FIG. 4-7. Referring to FIG. 11, there is shown a flowchart 1100 that illustrates operations 1102 through 1120 for optimizing multi-task execution of AI models. In a non-limiting example, the flowchart 1100 is explained with reference to the multi-task device 400 of FIGS. 4 and 5A-5C.

At 1102, input data is received. For example, the processor(s) 102 may be configured to receive the input data either from the device component(s) 112 or an external device. At 1104, a memory partition of an execution memory is acquired for an encoding model. For example, the processor(s) 102 may be configured to acquire the second memory partition 502B for the encoding model 402.

At 1106, the acquired memory partition is loaded with the encoding model. For example, the processor(s) 102 may be configured to load the second memory partition 502B with the encoding model 402. While the second memory partition 502B is loaded with the encoding model 402, the first memory partition 502A may remain unallocated to receive an output of the encoding model 402.

At 1108, the loaded encoding model may be executed based on the received input data. For example, the processor(s) 102 may be configured to executed the encoding model 402 based on the received input data. In an example, execution of the encoding model 402 may include application of one or more multi-purpose transformations on the input data and generation of the representation output 504. The representation output 504 can be in the form of, for example, a feature map, an embedding, a latent vector, a compressed representation, or the like.

At 1110, the memory partition may be released upon a completion of the execution of the encoding model. For example, the processor(s) 102 may be configured to release the second memory partition 502B based on the completion of the execution of the encoding model 402 such as upon the generation of the representation output 504.

At 1112, the processor(s) 102 may be configured to determine if local decoding models are available for execution. For example, a device may function as an encoder but may have offloaded decoding functionality to a remote or an external device. If at 1112, the processor(s) 102 determine that local decoding models are unavailable, control may pass to 1114. At 1114, a representation output of the executed encoding model is transmitted to a decoding device. For example, the processor(s) 102 may be configured to transmit the representation output 504 to a decoding device such as the multi-task device 100 of FIG. 1, and control may pass to 1102 for receiving subsequent input data.

If at 1112, the processor(s) 102 determine that local decoding models are available, control may pass to 1116. At 1116, a first memory partition of the execution memory is acquired to provide the representation output. For example, the processor(s) 102 may be configured to acquire the first memory partition 502A in the execution memory 106 to provide the representation output 504 for decoding. In other words, the representation output 504 may be obtained in the first memory partition 502A.

At 1118, based on the representation output in the first memory partition, one or more decoding models for respective one or more tasks utilizing one or more second memory partitions of the execution memory, respectively, may be executed. For example, the processor(s) 102 may be configured to one or more of the first decoding model 104A and the second decoding model 104B based on the representation output 504 in the first memory partition 502A. Further, the processor(s) 102 may be configured to utilize the one or more second memory partitions of the execution memory 106 that were unallocated for decoding. Execution of the decoding models 104 using the shared memory feature of the execution memory 106 is described in the foregoing description of FIGS. 1-7.

At 1120, the first memory partition is released upon a completion of the execution of the one or more decoding models. For example, the processor(s) 102 may be configured to release the first memory partition 502A upon the completion of the execution of the one or more decoding models.

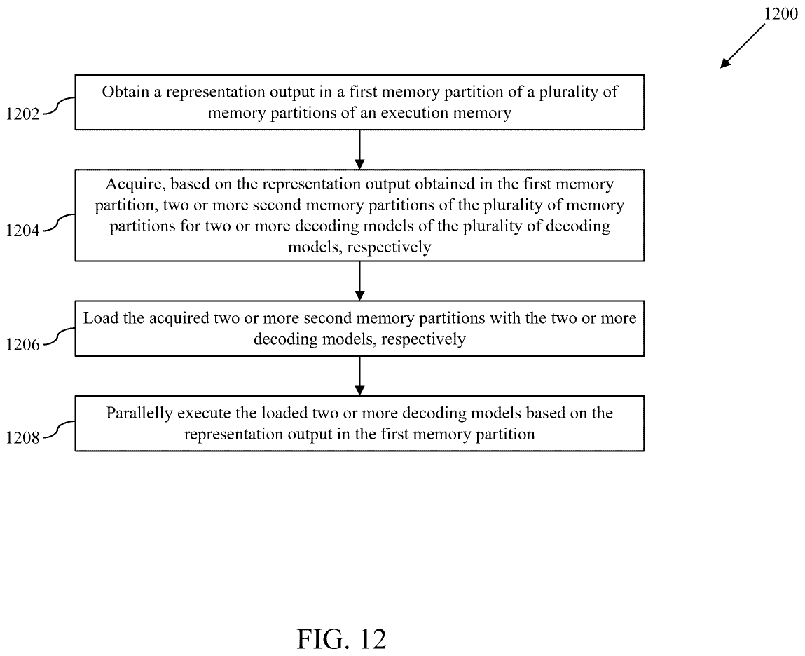

FIG. 12 is a high-level flowchart that illustrates a method (e.g., a process) executed at a device to optimize multi-task execution of AI models, in accordance with certain aspects of the present disclosure. In many examples, the device can be the multi-task device 100, the multi-task device 400, the multi-task XR device 602, 702, or the multi-task computing device 608 described in the foregoing description of FIG. 1-7. Referring to FIG. 12, there is shown a flowchart 1200 that illustrates operations 1202 through 1208 for optimizing multi-task execution of AI models. In a non-limiting example, the flowchart 1200 is explained with reference to the multi-task device 100 of FIGS. 1, 3A, and 3B.

At 1202, a representation output is obtained in a first memory partition of a plurality of memory partitions of an execution memory. For example, the processor(s) 102 may be configured to obtain the representation output 304 in the first memory partition 302A of the execution memory 106.

At 1204, based on the representation output obtained in the first memory partition, two or more second memory partitions of the plurality of memory partitions are acquired for two or more decoding models of the plurality of decoding models, respectively. For example, the processor(s) 102 may be configured to acquire the second memory partition 302B and the third memory partition 302C for the first decoding model 104A and the second decoding model 104B, respectively, based on the representation output 304 obtained in the first memory partition 302A.

At 1206, the acquired two or more second memory partitions are loaded with the two or more decoding models, respectively. For example, the processor(s) 102 may be configured to load the second memory partition 302B and the third memory partition 302C with the first decoding model 104A and the second decoding model 104B, respectively.

At 1208, the loaded two or more decoding models are parallelly executed based on the representation output in the first memory partition. For example, the processor(s) 102 may be configured to parallelly execute the first decoding model 104A and the second decoding model 104B based on the representation output 304 in the first memory partition 302A.

Thus, by leveraging a partitioned and sharable execution memory, a representation output of an encoding model is stored (e.g., obtained) in one of a plurality of memory partitions, allowing any decoding model(s) to be dynamically loaded into any of the remaining memory partitions of the plurality of memory partitions at respective inference cadences for execution. By enabling multiple decoding models to operate independently of the encoding model while still utilizing shared representation output from a memory partition of the execution memory, various aspects of the present disclosure allow the encoding model to be executed at the highest inference cadence among the decoding models without introducing memory bandwidth constraints or computational overhead.

Additionally, various aspects of the present disclosure may eliminate the involvement of main memory access to fetch the representation output of the isolated encoding model separately for each decoding model execution as the representation output remains in a memory partition of the execution memory until next representation output is obtained or until decoding models corresponding to the representation output are loaded and executed.

Additionally, executing multiple decoding models in a split mode (e.g., a split rendering mode) where the encoding model and the decoding models run separately, may allow for addition of new decoding models via OTA updates and an opportunity to optimize power consumption of devices with limited power capacity such as wearable electronics, IoT devices, etc. Such an approach may enable dynamic expansion of decoding capabilities of the device, where the one or more processors can be updated to integrate newly added decoding models without disrupting operations of the existing decoding models.

Techniques consistent with the present disclosure provide, among other features, systems, and methods for memory management for multi-task execution of AI models.

Aspects in the present disclosure enable two or more decoding models to operate independently of a common encoding model while still utilizing shared representation output of the encoding model without impacting main memory access. Various aspects of the present disclosure allow the encoding model to be executed at the highest inference cadence without introducing memory bandwidth constraints or computational overhead. Additionally, various aspects of the present disclosure may eliminate the involvement of main memory access to fetch a representation output of the isolated encoding model separately for each decoding model execution as the representation output remains in a memory partition of an execution memory until next representation output is obtained or until decoding models corresponding to the representation output are loaded and executed.

Some implementation examples are described in the following numbered aspects:

Aspect 1: A method, comprising: obtaining a representation output in a first memory partition of a plurality of memory partitions of an execution memory; acquiring, based on the representation output obtained in the first memory partition, a second memory partition of the plurality of memory partitions for a first decoding model of two or more decoding models, wherein the two or more decoding models are associated with two or more tasks, respectively; loading the acquired second memory partition with the first decoding model; and executing the loaded first decoding model based on the representation output in the first memory partition.

Aspect 2: The method of aspect 1, comprising providing an identifier of the first memory partition as an input to the first decoding model to execute the loaded first decoding model.

Aspect 3: The method of any of aspects 1 through 2, wherein the execution of the loaded first decoding model comprises an application of one or more task-specific transformations on the representation output, and a generation, based on the application of the one or more task-specific transformations, of a task-specific output for a task, among the two or more tasks, associated with the first decoding model.

Aspect 4: The method of aspect 3, comprising one or more device components, wherein the one or more processors are individually or collectively configured to control an operation of at least one device component of the one or more device components based on the task-specific output.

Aspect 5: The method of aspect 4, comprising rendering a visual content, modify the visual content based on the task-specific output, render the modified visual content, based on the control of the operation.

Aspect 6: The method of aspect 5, wherein the modification of the visual content comprises at least one of: an overlay of one or more information cues on the rendered visual content, an adjustment of at least one visual property of the rendered visual content, and a reconfiguration of the rendered visual content.

Aspect 7: The method of any of aspects 1 through 6, wherein the two or more tasks comprise at least two of: object detection, background segmentation, human depth estimation, scene segmentation, scene light estimation, object tracking, gesture recognition, gaze tracking, or pose estimation.

Aspect 8: The method of any aspects 1 through 6, comprising tracking an availability status of each of the plurality of memory partitions; transitioning to a claimed state based on the availability status of the first memory partition being allocated and the availability status of the second memory partition being unallocated; and transitioning to a decoding state based on the availability status of each of the first memory partition and the second memory partition being allocated.

Aspect 9: The method of aspect 8, comprising releasing the first memory partition and the second memory partition upon a completion of the execution of the first decoding model; and transitioning to an unclaimed state based on the availability status of each of the first memory partition and the second memory partition being unallocated.

Aspect 10: The method of aspect 8, comprising releasing the acquired second memory partition upon a completion of the execution of the first decoding model; acquiring the second memory partition for a second decoding model of the two or more decoding models; loading the acquired second memory partition with the second decoding model; and executing the loaded second decoding model based on the obtained representation output.

Aspect 11: The method of aspect 10, comprising executing the second decoding model after the execution of the first decoding model based on the second decoding model having a lower priority than the first decoding model.

Aspect 12: The method of any of aspects 10 through 11, comprising releasing the first memory partition and the second memory partition upon a completion of the execution of the second decoding model; and transitioning to an unclaimed state based on the availability status of each of the first memory partition and the second memory partition being unallocated.

Aspect 13: The method of aspect 1, comprising acquiring a third memory partition of the plurality of memory partitions for a second decoding model of the two or more decoding models, wherein the third memory partition is different from the second memory partition; loading the acquired third memory partition with the second decoding model; and parallelly executing the loaded first decoding model and the loaded second decoding model based on the obtained representation output.

Aspect 14: The method of aspect 1, wherein the two or more decoding models are associated with respective inference cadences, and comprising identifying, among the two or more decoding models, a set of decoding models to load in the second memory partition based on the respective inference cadences of the two or more decoding models, wherein the set of decoding models comprises at least the first decoding model having a highest inference cadence among the respective inference cadences of the two or more decoding models. The identification is prior to the loading of the acquired second memory partition with the first decoding model.

Aspect 15: The method of aspect 14, comprising tracking an availability status of each of the plurality of memory partitions; transitioning to a claimed state based on the availability status of the first memory partition being allocated and the availability status of the second memory partition being unallocated; transitioning to a decoding state based on the availability status of each of the first memory partition and the second memory partition being allocated; and transitioning to an unclaimed state based on the availability status of each of the first memory partition and the second memory partition being unallocated.

Aspect 16: The method of any of aspects 1 through 15, comprising receiving input data, acquiring, based on the reception of the input data, the second memory partition for an encoding model associated with the two or more decoding models; loading the acquired second memory partition with the encoding model; executing the loaded encoding model based on the received input data; acquire the first memory partition to provide the representation output of the executed encoding model; and releasing the second memory partition upon a completion of the execution of the encoding model. The reception of the input data is prior to the obtaining of the representation output in the first memory partition.

Aspect 17: The method of aspect 16, comprising tracking an availability status of each of the plurality of memory partitions; transitioning to an encoding state based on the availability status of the second memory partition being allocated and the availability status of the first memory partition being unallocated; transitioning to a claimed stated based on the availability status of the first memory partition being allocated and the availability status of the second memory partition being unallocated; transitioning to a decoding state based on the availability status of each of the first memory partition and the second memory partition being allocated; and transitioning to an unclaimed state based on the availability status of each of the first memory partition and the second memory partition being unallocated.

Aspect 18: The method of any of aspects 1 through 17, wherein the execution memory comprises a tightly coupled memory (TCM), and the first memory partition corresponds to an overmap segment in the TCM.

Aspect 19: The method of any of aspects 1 through 18, storing the two or more decoding models in a main memory of the device, and loading the acquired second memory partition with the first decoding model from the main memory based on the acquiring of the second memory partition.

Aspect 20: A method, comprising: obtaining a representation output in a first memory partition of a plurality of memory partitions of an execution memory of a device; acquiring, based on the representation output obtained in the first memory partition, two or more second memory partitions of the plurality of memory partitions for two or more decoding models of a plurality of decoding models, respectively; loading the acquired two or more second memory partitions with the two or more decoding models, respectively; and parallelly executing the loaded two or more decoding models based on the representation output in the first memory partition.

Aspect 21: An apparatus, comprising two or more decoding models associated with two or more tasks, respectively; an execution memory comprising a plurality of memory partitions; and one or more processors coupled to the execution memory, the one or more processors individually or collectively configured to cause the apparatus to perform a method of any of aspects 1 through 19.

Aspect 22: An apparatus, comprising at least one means for performing a method of any of aspects 1 through 19.

Aspect 23: A non-transitory computer-readable medium storing code for multi-task execution at a device, the code comprising instructions executable by a processor to perform a method of any of aspects 1 through 19.

Aspect 24: An apparatus, comprising a plurality of decoding models associated with a plurality of tasks, respectively; an execution memory comprising a plurality of memory partitions; and one or more processors coupled to the execution memory, the one or more processors individually or collectively configured to cause the apparatus to perform a method of aspects 20.

Aspect 25: An apparatus, comprising at least one means for performing a method of aspect 20.

Aspect 26: A non-transitory computer-readable medium storing code for multi-task execution at a device, the code comprising instructions executable by a processor to perform a method of aspect 20.

It is understood that the specific order or hierarchy of steps in the processes disclosed is an illustration of example approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A device, comprising:
two or more decoding models associated with two or more tasks, respectively;
an execution memory comprising a plurality of memory partitions; and
one or more processors coupled to the execution memory, the one or more processors individually or collectively configured to:
obtain a representation output in a first memory partition of the plurality of memory partitions;
acquire, based on the representation output obtained in the first memory partition, a second memory partition of the plurality of memory partitions for a first decoding model of the two or more decoding models;
load the acquired second memory partition with the first decoding model; and
execute the loaded first decoding model based on the representation output in the first memory partition.

2. The device of claim 1, wherein to execute the loaded first decoding model, the one or more processors are individually or collectively configured to provide an identifier of the first memory partition as an input to the first decoding model.

3. The device of claim 1, wherein the execution of the loaded first decoding model comprises an application of one or more task-specific transformations on the representation output, and a generation, based on the application of the one or more task-specific transformations, of a task-specific output for a task, among the two or more tasks, associated with the first decoding model.

4. The device of claim 3, comprising one or more device components, wherein the one or more processors are individually or collectively configured to control an operation of at least one device component of the one or more device components based on the task-specific output.

5. The device of claim 4, wherein
the at least one device component comprises a display, and
based on the control of the operation, the display is configured to:
render a visual content;
modify the visual content based on the task-specific output; and
render the modified visual content.

6. The device of claim 5, wherein the modification of the visual content comprises at least one of:
an overlay of one or more information cues on the rendered visual content,
an adjustment of at least one visual property of the rendered visual content, or
a reconfiguration of the rendered visual content.

7. The device of claim 1, wherein the two or more tasks comprise at least two of: object detection, background segmentation, human depth estimation, scene segmentation, scene light estimation, object tracking, gesture recognition, gaze tracking, or pose estimation.

8. The device of claim 1, wherein the one or more processors are individually or collectively configured to:
track an availability status of each of the plurality of memory partitions;
transition to a claimed state based on the availability status of the first memory partition being allocated and the availability status of the second memory partition being unallocated; and
transition to a decoding state based on the availability status of each of the first memory partition and the second memory partition being allocated.

9. The device of claim 8, wherein the one or more processors are individually or collectively configured to:
release the first memory partition and the second memory partition upon a completion of the execution of the first decoding model; and
transition to an unclaimed state based on the availability status of each of the first memory partition and the second memory partition being unallocated.

10. The device of claim 8, wherein the one or more processors are individually or collectively configured to:
release the acquired second memory partition upon a completion of the execution of the first decoding model;
acquire the second memory partition for a second decoding model of the two or more decoding models;
load the acquired second memory partition with the second decoding model; and
execute the loaded second decoding model based on the obtained representation output.

11. The device of claim 10, wherein the one or more processors individually or collectively are configured to execute the second decoding model after the execution of the first decoding model based on the second decoding model having a lower priority than the first decoding model.

12. The device of claim 10, wherein the one or more processors are individually or collectively configured to:
release the first memory partition and the second memory partition upon a completion of the execution of the second decoding model; and
transition to an unclaimed state based on the availability status of each of the first memory partition and the second memory partition being unallocated.

13. The device of claim 1, wherein the one or more processors are individually or collectively configured to:
acquire a third memory partition of the plurality of memory partitions for a second decoding model of the two or more decoding models, wherein the third memory partition is different from the second memory partition;
load the acquired third memory partition with the second decoding model; and
parallelly execute the loaded first decoding model and the loaded second decoding model based on the obtained representation output.

14. The device of claim 1, wherein
the two or more decoding models are associated with respective inference cadences, and
prior to loading the acquired second memory partition with the first decoding model, the one or more processors are individually or collectively configured to:
identify, among the two or more decoding models, a set of decoding models to load in the second memory partition based on the respective inference cadences of the two or more decoding models, wherein the set of decoding models comprises at least the first decoding model having a highest inference cadence among the respective inference cadences of the two or more decoding models.

15. The device of claim 14, wherein the one or more processors are individually or collectively configured to:
track an availability status of each of the plurality of memory partitions;
transition to a claimed state based on the availability status of the first memory partition being allocated and the availability status of the second memory partition being unallocated;
transition to a decoding state based on the availability status of each of the first memory partition and the second memory partition being allocated; and
transition to an unclaimed state based on the availability status of each of the first memory partition and the second memory partition being unallocated.

16. The device of claim 1, comprising an encoding model associated with the two or more decoding models, wherein prior to the obtaining of the representation output in the first memory partition, the one or more processors are individually or collectively configured to:
receive input data;
acquire the second memory partition for the encoding model based on the reception of the input data;
load the acquired second memory partition with the encoding model;
execute the loaded encoding model based on the received input data;
acquire the first memory partition to provide the representation output of the executed encoding model; and
release the second memory partition upon a completion of the execution of the encoding model.

17. The device of claim 16, wherein the one or more processors are individually or collectively configured to:
track an availability status of each of the plurality of memory partitions;
transition to an encoding state based on the availability status of the second memory partition being allocated and the availability status of the first memory partition being unallocated;
transition to a claimed stated based on the availability status of the first memory partition being allocated and the availability status of the second memory partition being unallocated;
transition to a decoding state based on the availability status of each of the first memory partition and the second memory partition being allocated; and
transition to an unclaimed state based on the availability status of each of the first memory partition and the second memory partition being unallocated.

18. The device of claim 1, wherein the execution memory comprises a tightly coupled memory (TCM), and the first memory partition corresponds to an overmap segment in the TCM.

19. The device of claim 1, comprising a main memory coupled to the one or more processors, wherein the main memory is configured to store the two or more decoding models, and the one or more processors are individually or collectively configured to load the acquired second memory partition with the first decoding model from the main memory based on the acquiring of the second memory partition.

20. A method, comprising:
obtaining a representation output in a first memory partition of a plurality of memory partitions of an execution memory;
acquiring, based on the representation output obtained in the first memory partition, a second memory partition of the plurality of memory partitions for a first decoding model of two or more decoding models, wherein the two or more decoding models are associated with two or more tasks, respectively;
loading the acquired second memory partition with the first decoding model; and
executing the loaded first decoding model based on the representation output in the first memory partition.
